(19) United States
(12) Patent Application Publication
(10) Pub. No.: US 2026/0353292 A1
(43) Pub. Date: Nov. 5, 2026

(54) TIMER-BASED SLEEP MODES

(71) Applicant: QUALCOMM Incorporated, San Diego, CA (US)

(72) Inventors: Jung Ho RYU, Englewood Cliffs, NJ (US); Igor GUTMAN, Hod HaSharon (IL); Hemant SAGGAR, San Diego, CA (US); Navid ABEDINI, Basking Ridge, NJ (US)

(21) Appl. No.: 19/197,876

(22) Filed: May 2, 2025

(51) Int. Cl. H04W 52/02; H04L 5/00

(52) U.S. Cl. CPC H04W 52/0235; H04L 5/0053; H04W 52/028

(57) ABSTRACT

Various aspects of the present disclosure generally relate to wireless communication. In some aspects, a user equipment (UE) may communicate, with a network node, a light sleep mode message indicating activation of a light sleep mode, wherein the light sleep mode includes a first reduced power state in which a main radio transceiver of the UE is partially deactivated. The UE may enter the light sleep mode in accordance with communicating the light sleep mode indication. The UE may activate a deep sleep mode timer for entering a deep sleep mode in accordance with activating the light sleep mode, wherein the deep sleep mode includes a second reduced power state in which the main radio transceiver of the UE is more deactivated than in the light sleep mode. Numerous other aspects are described.

### FIELD OF THE DISCLOSURE

Aspects of the present disclosure generally relate to wireless communication and specifically relate to techniques, apparatuses, and methods associated with timer-based sleep modes.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

A user equipment (UE) may be equipped with a communication system that includes a main radio and a low power wake-up radio (LP-WUR) to reduce power consumption and enable low latency. Power saving and low latency, in some examples, may be conflicting goals, because placing one or more components into a sleep state more often to reduce power consumption may increase latency (e.g., because data is not communicated while the one or more components are in the sleep state), and because reducing the time that one or more components spend in a sleep state to reduce latency may lead to increased power consumption. Accordingly, a UE may be equipped with an LP-WUR to receive a low power wake-up signal (LP-WUS), which may be considered a companion receiver that may be used with a main radio to reduce power consumption and latency by providing a mechanism for communicating with a UE in a sleep mode.

A UE may also operate in a connected mode discontinuous reception (C-DRX) mode based at least in part on a discontinuous reception (DRX) cycle that includes a DRX “on” duration during which the main radio of the UE operates in an active mode and may monitor for one or more communications from a network node. The DRX cycle may additionally include a DRX “off” duration during which the main radio of the UE operates in a sleep state. The DRX cycle may repeat with a configured periodicity according to a DRX configuration indicated by a network node.

An LP-WUS is relatively simple signal that may be processed by a low-power receiver, such as an LP-WUR, enabling the main radio of the UE to remain in a low-power state, for example, until the main radio is needed for relatively complex (e.g., more complex than an LP-WUS) communications. The use of LP-WUSs in conjunction with C-DRX may allow the UE to remain in a sleep mode for longer periods, and the UE may consume a lower amount of power while in a sleep mode (such as while not connected to a network or while waiting for paging from the network), and may consume a higher amount of power while in an active mode (such as while actively communicating with a network node or while monitoring for control information from the network).

### SUMMARY

The systems, methods, and devices of this disclosure each have several innovative aspects, no single one of which is solely responsible for the desirable attributes disclosed herein.

Some aspects described herein relate to a user equipment (UE). The UE may include a processing system. The processing system may include one or more processors and one or more code-storing memories coupled with the one or more processors. The processing system may be configured to cause the UE to communicate, with a network node, a light sleep mode message indicating activation of a light sleep mode, wherein the light sleep mode includes a first reduced power state in which a main radio transceiver of the UE is partially deactivated. The processing system may be configured to cause the UE to enter the light sleep mode in accordance with communicating the light sleep mode indication. The processing system may be configured to cause the UE to activate a deep sleep mode timer for entering a deep sleep mode in accordance with activating the light sleep mode, wherein the deep sleep mode includes a second reduced power state in which the main radio transceiver of the UE is less activated than in the light sleep mode.

Some aspects described herein relate to a UE. The UE may include a processing system. The processing system may include one or more processors and one or more code-storing memories coupled with the one or more processors. The processing system may be configured to cause the UE to receive, from a network node, a control channel message that schedules a communication between the UE and the network node, wherein a new data indicator of the control channel message indicates that the communication includes a new communication. The processing system may be configured to cause the UE to initiate a timer in reaction to receiving the control channel message, wherein the timer corresponds to the communication. The processing system may be configured to cause the UE to override one or more discontinuous reception cycles for a duration of the timer according to a wake mode of the UE.

Some aspects described herein relate to a network node. The network node may include a processing system. The processing system may include one or more processors and one or more code-storing memories coupled with the one or more processors. The processing system may be configured to cause the network node to communicate, with a UE, a light sleep mode message indicating activation of a light sleep mode, wherein the light sleep mode includes a first reduced power state in which a main radio transceiver of the UE is partially deactivated. The processing system may be configured to cause the network node to communicate with the UE according to a deep sleep mode timer for triggering a deep sleep mode of the UE, wherein the deep sleep mode includes a second reduced power state in which the main radio transceiver of the UE is more deactivated than in the light sleep mode.

Some aspects described herein relate to a network node. The network node may include a processing system. The processing system may include one or more processors and one or more code-storing memories coupled with the one or more processors. The processing system may be configured to cause the network node to transmit, to a UE, a control channel message that schedules a communication between the UE and the network node, wherein a new data indicator of the control channel message indicates that the communication includes a new communication. The processing system may be configured to cause the network node to communicate with the UE while a timer that corresponds to the communication is activated.

Some aspects described herein relate to a method of wireless communication performed by a UE. The method may include communicating, with a network node, a light sleep mode message indicating activation of a light sleep mode, wherein the light sleep mode includes a first reduced power state in which a main radio transceiver of the UE is partially deactivated. The method may include entering the light sleep mode in accordance with communicating the light sleep mode indication. The method may include activating a deep sleep mode timer for entering a deep sleep mode in accordance with activating the light sleep mode, wherein the deep sleep mode includes a second reduced power state in which the main radio transceiver of the UE is more deactivated than in the light sleep mode.

Some aspects described herein relate to a method of wireless communication performed by a UE. The method may include receiving, from a network node, a control channel message that schedules a communication between the UE and the network node, wherein a new data indicator of the control channel message indicates that the communication includes a new communication. The method may include initiating a timer in reaction to receiving the control channel message, wherein the timer corresponds to the communication. The method may include overriding one or more discontinuous reception cycles for a duration of the timer according to a wake mode of the UE.

Some aspects described herein relate to a method of wireless communication performed by a network node. The method may include communicating, with a UE, a light sleep mode message indicating activation of a light sleep mode, wherein the light sleep mode includes a first reduced power state in which a main radio transceiver of the UE is partially deactivated. The method may include communicating with the UE according to a deep sleep mode timer for triggering a deep sleep mode of the UE, wherein the deep sleep mode includes a second reduced power state in which the main radio transceiver of the UE is more deactivated than in the light sleep mode.

Some aspects described herein relate to a method of wireless communication performed by a network node. The method may include transmitting, to a UE, a control channel message that schedules a communication between the UE and the network node, wherein a new data indicator of the control channel message indicates that the communication includes a new communication. The method may include communicating with the UE while a timer that corresponds to the communication is activated.

Some aspects described herein relate to a non-transitory computer-readable medium that stores a set of instructions for wireless communication by a UE. The set of instructions, when executed by one or more processors of the UE, may cause the UE to communicate, with a network node, a light sleep mode message indicating activation of a light sleep mode, wherein the light sleep mode includes a first reduced power state in which a main radio transceiver of the UE is partially deactivated. The set of instructions, when executed by one or more processors of the UE, may cause the UE to enter the light sleep mode in accordance with communicating the light sleep mode indication. The set of instructions, when executed by one or more processors of the UE, may cause the UE to activate a deep sleep mode timer for entering a deep sleep mode in accordance with activating the light sleep mode, wherein the deep sleep mode includes a second reduced power state in which the main radio transceiver of the UE is more deactivated than in the light sleep mode.

Some aspects described herein relate to a non-transitory computer-readable medium that stores a set of instructions for wireless communication by a UE. The set of instructions, when executed by one or more processors of the UE, may cause the UE to receive, from a network node, a control channel message that schedules a communication between the UE and the network node, wherein a new data indicator of the control channel message indicates that the communication includes a new communication. The set of instructions, when executed by one or more processors of the UE, may cause the UE to initiate a timer in reaction to receiving the control channel message, wherein the timer corresponds to the communication. The set of instructions, when executed by one or more processors of the UE, may cause the UE to override one or more discontinuous reception cycles for a duration of the timer according to a wake mode of the UE.

Some aspects described herein relate to a non-transitory computer-readable medium that stores a set of instructions for wireless communication by a network node. The set of instructions, when executed by one or more processors of the network node, may cause the network node to communicate, with a UE, a light sleep mode message indicating activation of a light sleep mode, wherein the light sleep mode includes a first reduced power state in which a main radio transceiver of the UE is partially deactivated. The set of instructions, when executed by one or more processors of the network node, may cause the network node to communicate with the UE according to a deep sleep mode timer for triggering a deep sleep mode of the UE, wherein the deep sleep mode includes a second reduced power state in which the main radio transceiver of the UE is more deactivated than in the light sleep mode.

Some aspects described herein relate to a non-transitory computer-readable medium that stores a set of instructions for wireless communication by a network node. The set of instructions, when executed by one or more processors of the network node, may cause the network node to transmit, to a UE, a control channel message that schedules a communication between the UE and the network node, wherein a new data indicator of the control channel message indicates that the communication includes a new communication. The set of instructions, when executed by one or more processors of the network node, may cause the network node to communicate with the UE while a timer that corresponds to the communication is activated.

Some aspects described herein relate to an apparatus for wireless communication. The apparatus may include means for communicating, with a network node, a light sleep mode message indicating activation of a light sleep mode, wherein the light sleep mode includes a first reduced power state in which a main radio transceiver of the apparatus is partially deactivated. The apparatus may include means for entering the light sleep mode in accordance with communicating the light sleep mode indication. The apparatus may include means for activating a deep sleep mode timer for entering a deep sleep mode in accordance with activating the light sleep mode, wherein the deep sleep mode includes a second reduced power state in which the main radio transceiver of the apparatus is more deactivated than in the light sleep mode.

Some aspects described herein relate to an apparatus for wireless communication. The apparatus may include means for receiving, from a network node, a control channel message that schedules a communication between the apparatus and the network node, wherein a new data indicator of the control channel message indicates that the communication includes a new communication. The apparatus may include means for initiating a timer in reaction to receiving the control channel message, wherein the timer corresponds to the communication. The apparatus may include means for overriding one or more discontinuous reception cycles for a duration of the timer according to a wake mode of the apparatus.

Some aspects described herein relate to an apparatus for wireless communication. The apparatus may include means for communicating, with a UE, a light sleep mode message indicating activation of a light sleep mode, wherein the light sleep mode includes a first reduced power state in which a main radio transceiver of the UE is partially deactivated. The apparatus may include means for communicating with the UE according to a deep sleep mode timer for triggering a deep sleep mode of the UE, wherein the deep sleep mode includes a second reduced power state in which the main radio transceiver of the UE is more deactivated than in the light sleep mode.

Some aspects described herein relate to an apparatus for wireless communication. The apparatus may include means for transmitting, to a UE, a control channel message that schedules a communication between the UE and the apparatus, wherein a new data indicator of the control channel message indicates that the communication includes a new communication. The apparatus may include means for communicating with the UE while a timer that corresponds to the communication is activated.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless communication network.

FIG. 2 is a diagram illustrating an example of a low-power wake-up radio (LP-WUR) and a low-power wake-up signal (LP-WUS).

FIG. 3 is a diagram illustrating an example of LP-WUS waveforms.

FIG. 4 is a diagram illustrating an example of a discontinuous reception (DRX) configuration.

FIG. 5 is a diagram of an example associated with timer-based sleep modes.

FIG. 6 is a diagram illustrating an example associated with a light sleep mode and a deep sleep mode timer, in accordance with the present disclosure.

FIG. 7 is a diagram illustrating an example associated with ramp-up times for transitioning to an active mode, in accordance with the present disclosure.

FIG. 8 is a diagram illustrating an example of timers for a DRX configuration.

FIG. 9 is a diagram illustrating an example process performed, for example, at a user equipment (UE) or an apparatus of a UE.

FIG. 10 is a diagram illustrating an example process performed, for example, at a UE or an apparatus of a UE.

FIG. 11 is a diagram illustrating an example process performed, for example, at a network node or an apparatus of a network node.

FIG. 12 is a diagram illustrating an example process performed, for example, at a network node or an apparatus of a network node.

FIG. 13 is a diagram of an example apparatus for wireless communication.

FIG. 14 is a diagram of an example apparatus for wireless communication.

### DETAILED DESCRIPTION

A user equipment (UE) may be equipped with a communication system that includes a main radio and a low power wake-up radio (LP-WUR) to reduce power consumption and enable low latency. Power saving and low latency are often conflicting goals because placing one or more components into a sleep state more often to reduce power consumption also increases latency (e.g., because data cannot be transmitted and/or received while the one or more components are in the sleep state), and because reducing the time that one or more components spend in a sleep state to reduce latency may lead to increased power consumption. Accordingly, the UE may be equipped with the LP-WUR, which may be considered a companion receiver that may be used with a main radio to reduce power consumption and latency.

A UE may also operate in a connected mode discontinuous reception (C-DRX) mode based at least in part on a discontinuous reception (DRX) cycle that includes a DRX on duration during which a main radio of the UE operates in an active state and a DRX sleep state during which the main radio of the UE operates in a sleep state. As a result, the UE may conserve battery power and reduce power consumption. The DRX cycle may repeat with a configured periodicity according to a DRX configuration indicated by a network node.

In contemporary wireless communication systems, achieving energy efficiency for UEs is an increasingly important concern. Some UEs, including those operating in a radio resource control (RRC) connected mode, may implement power-saving procedures to conserve energy, reduce power consumption, and extend battery life. One such procedure is DRX, which enables the UE to periodically enter a sleep mode during which the UE does not monitor for control messages, thereby saving power.

The standardization of power-saving features often involves the use of timers that control periods of activity and inactivity. For instance, C-DRX is an established procedure where a UE wakes at scheduled intervals to monitor for control messages from the network on the physical downlink control channel (PDCCH). The scheduling is determined by timers such as the drx-OnDurationTimer, which defines the active monitoring period, and the drx-InactivityTimer, which extends the active period following the detection of new transmissions. However, the fixed periodicity of PDCCH monitoring, once configured, obligates the UE to power up and monitor the channel at each interval, regardless of whether there is a control message to be received, which may limit power savings and affect latency performance.

Despite these advancements, there are technical challenges associated with the integration and operation of LP-WUS with existing power-saving protocols like C-DRX. For instance, determining the optimal timing for the UE to transition between different levels of sleep states, such as light sleep and deep sleep, is nontrivial. Moreover, scenarios exist where the UE may be prompted to exit sleep mode unnecessarily due to the initiation of inactivity timers following certain network commands, such as a request to transmit a channel state information (CSI) report.

The current specifications define that the inactivity timer be started upon any new transmission indicated by the PDCCH, which may lead to the UE maintaining an active state without substantial need for communication, which may result in energy inefficiency as the UE remains awake even when there is no further data exchange anticipated, thereby undermining the intended power-saving benefits.

Various aspects relate generally to a method where a UE communicates with a network node to indicate activation of a light sleep mode, which involves a first reduced power state where the main radio transceiver of the UE is partially deactivated. Upon entering the light sleep mode, the UE may activate a deep sleep mode timer to transition to a deep sleep mode after a specified duration, which includes a second reduced power state with the main radio transceiver more deactivated than in the light sleep mode.

In some aspects, the UE transitions from light sleep to deep sleep mode upon the expiration of the deep sleep mode timer. When the UE receives a wake-up signal or control message during the light sleep mode, the UE may quickly (e.g., relatively quickly, as compared to during the deep sleep mode) activate the main radio transceiver and enter an active mode to perform necessary communications.

Particular aspects of the subject matter described in this disclosure can be implemented to realize one or more of the following potential technical benefits. For example, timer-based sleep modes may improve energy efficiency and power management for a UE implementing power-saving features and may enhance overall efficiency. Implementing a deep sleep mode timer, or communication-specific inactivity timers, within existing power-saving features may contribute to more effective power management in UE devices, ultimately leading to improved battery life and user experience. In some aspects, the described techniques can be used to maintain a balance between power consumption and latency. In some aspects, by employing a deep sleep mode timer that governs the transition between light and deep sleep modes, the UE may optimize its power management to efficiently control the states of the main radio transceiver. As a result, the UE may decrease energy consumption by adjusting the level of radio transceiver activity to the expected communication demands by implementing varying degrees of sleep modes.

The described techniques can improve energy utilization of the UE by systematically controlling the activation state of the main radio transceiver. This may be accomplished through the use of inactivity timers correlated to the communication type, overriding standard discontinuous reception cycles, and reducing the active period of the UE when no data exchange is foreseen.

In some technical implementations, the network node may transmit control messages that time-synchronize communications with the UE, initiating timers that correspond to the scheduled activity, which may result in reducing the active state duration of the UE, thereby conserving battery resources and potentially extending the operational life of the UE's battery.

In this way, the advanced power management protocols and their standardization contribute to a reduction in energy usage of UE devices, which may support resource conservation within some wireless communication networks, potentially reducing energy expenditures and mitigating environmental impact associated with mobile technology operations.

5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

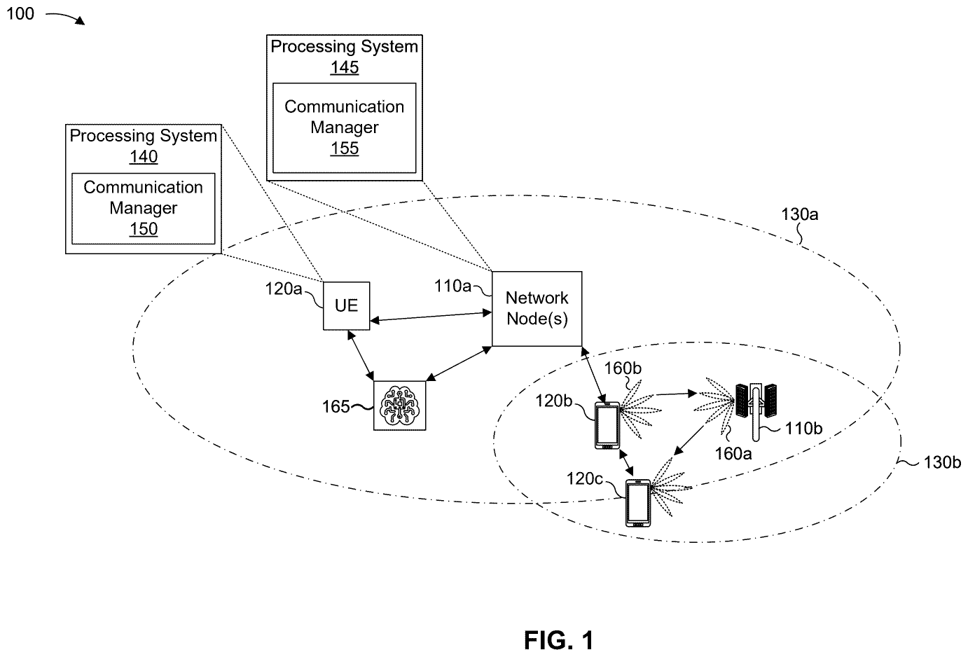

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as an RRC layer, a packet data convergence protocol (PDCP) layer, and a service data adaptation protocol (SDAP) layer, among other examples. A CU can communicate with a core network either directly (for example, via a backhaul link) or indirectly (for example, via one or more disaggregated control units, such as a non-real-time (Non-RT) RAN intelligent controller (RIC) associated with a Service Management and Orchestration (SMO) framework or a near-real-time (Near-RT) RIC). A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. A CU may communicate with one or more DUs via respective midhaul links, such as via F1 interfaces. Each of the DUs may communicate with one or more RUs via respective fronthaul links. Each of the RUs may communicate with one or more UEs 120 via respective RF access links. In some deployments, a UE 120 may be simultaneously served by multiple RUs.

In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment (for example, an open cloud (O-Cloud) platform). An SMO framework may support RAN deployment and provisioning of non-virtualized and virtualized network elements.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, the UE 120 may include a communication manager 150. As described in more detail elsewhere herein, the communication manager 150 may communicate, with a network node, a light sleep mode message indicating activation of a light sleep mode, wherein the light sleep mode includes a first reduced power state in which a main radio transceiver of the UE 120 is partially deactivated; enter the light sleep mode in accordance with communicating the light sleep mode indication; and activate a deep sleep mode timer for entering a deep sleep mode in accordance with activating the light sleep mode, wherein the deep sleep mode includes a second reduced power state in which the main radio transceiver of the UE 120 is more deactivated than in the light sleep mode.

In some aspects, the communication manager 150 may receive, from the network node 110, a control channel message that schedules a communication between the UE 120 and the network node 110, wherein a new data indicator of the control channel message indicates that the communication includes a new communication; initiate a timer in reaction to receiving the control channel message, wherein the timer corresponds to the communication; and override one or more discontinuous reception cycles for a duration of the timer according to a wake mode of the UE 120. Additionally, or alternatively, the communication manager 150 may perform one or more other operations described herein.

In some aspects, the network node 110 may include a communication manager 155. As described in more detail elsewhere herein, the communication manager 155 may communicate, with the UE 120, a light sleep mode message indicating activation of a light sleep mode, wherein the light sleep mode includes a first reduced power state in which a main radio transceiver of the UE 120 is partially deactivated; and communicate with the UE 120 according to a deep sleep mode timer for triggering a deep sleep mode of the UE 120, wherein the deep sleep mode includes a second reduced power state in which the main radio transceiver of the UE 120 is more deactivated than in the light sleep mode.

In some aspects, the communication manager 155 may transmit, to the UE 120, a control channel message that schedules a communication between the UE 120 and the network node 110, wherein a new data indicator of the control channel message indicates that the communication includes a new communication; and communicate with the UE 120 while a timer that corresponds to the communication is activated. Additionally, or alternatively, the communication manager 155 may perform one or more other operations described herein.

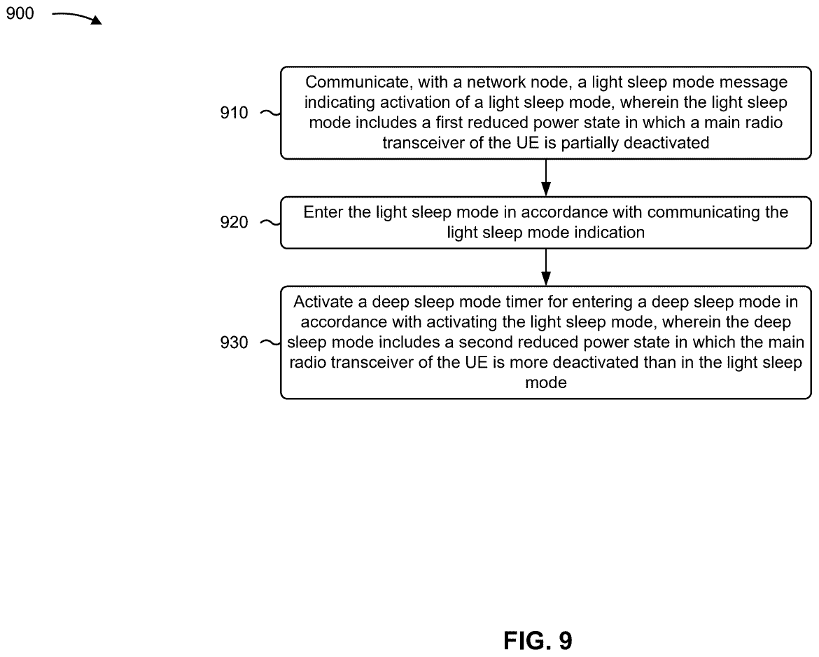

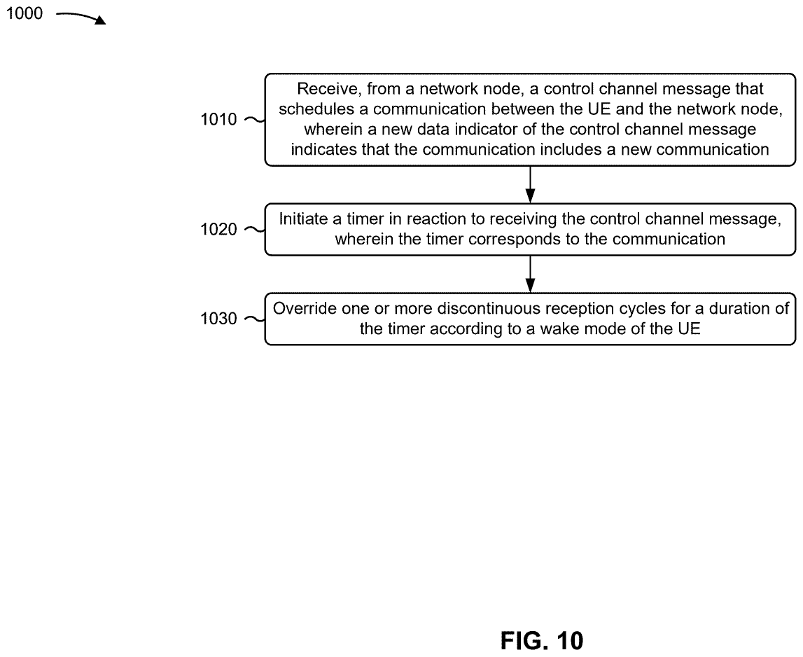

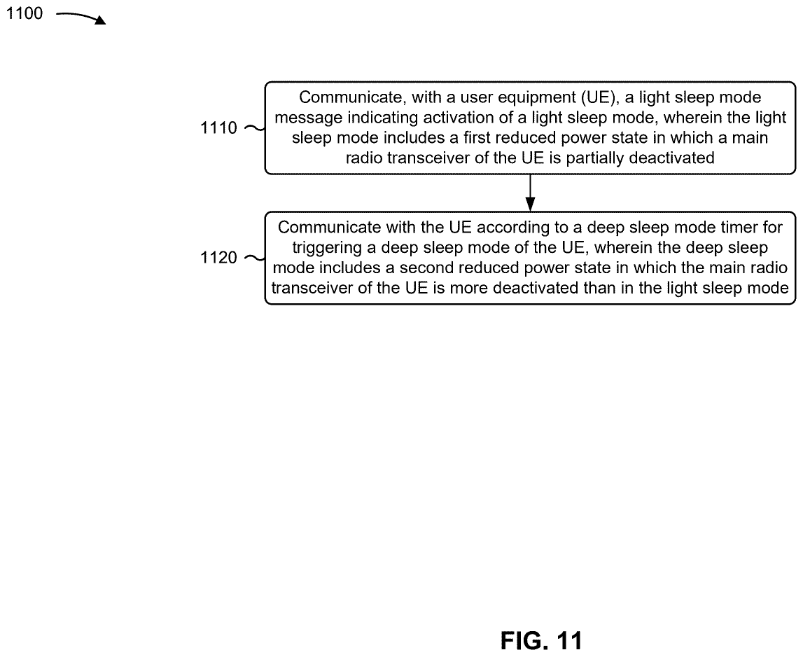

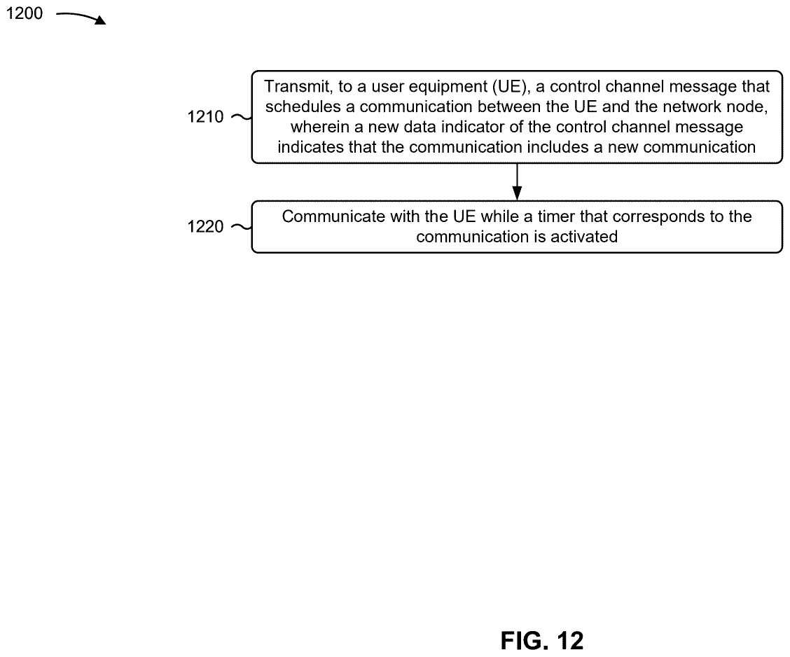

The network node 110, the processing system 145 of the network node 110, the UE 120, the processing system 140 of the UE 120, or any other component(s) of FIG. 1 may implement one or more techniques or perform one or more operations associated with timer-based sleep modes, as described in more detail elsewhere herein. For example, the processing system 145 of the network node 110, or the processing system 140 of the UE 120 may perform or direct operations of, for example, process 900 of FIG. 9, process 1000 of FIG. 10, process 1100 of FIG. 11, process 1200 of FIG. 12, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, or the UE 120, may cause the one or more processors to perform process 900 of FIG. 9, process 1000 of FIG. 10, process 1100 of FIG. 11, process 1200 of FIG. 12, or other processes as described herein. In some examples, executing instructions may include running the instructions, converting the instructions, compiling the instructions, or interpreting the instructions, among other examples.

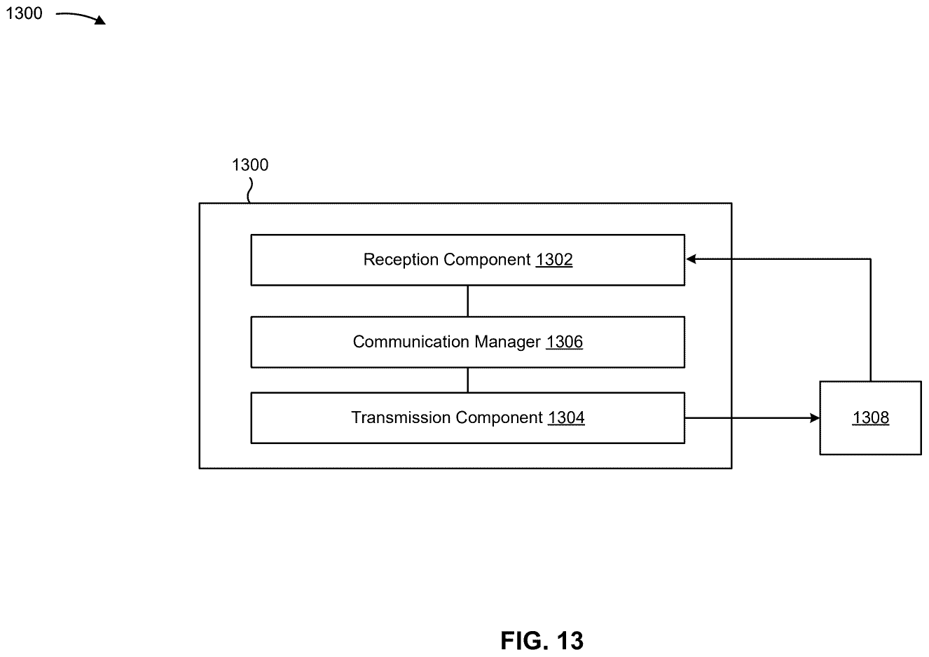

In some aspects, the UE 120 includes means for communicating, with the network node 110, a light sleep mode message indicating activation of a light sleep mode, wherein the light sleep mode includes a first reduced power state in which a main radio transceiver of the UE 120 is partially deactivated; means for entering the light sleep mode in accordance with communicating the light sleep mode indication; or means for activating a deep sleep mode timer for entering a deep sleep mode in accordance with activating the light sleep mode, wherein the deep sleep mode includes a second reduced power state in which the main radio transceiver of the UE 120 is more deactivated than in the light sleep mode. The means for the UE 120 to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

In some aspects, the UE 120 includes means for receiving, from the network node 110, a control channel message that schedules a communication between the UE 120 and the network node 110, wherein a new data indicator of the control channel message indicates that the communication includes a new communication; means for initiating a timer in reaction to receiving the control channel message, wherein the timer corresponds to the communication; or means for overriding one or more discontinuous reception cycles for a duration of the timer according to a wake mode of the UE 120. The means for the UE 120 to perform operations described herein may include, for example, one or more of communication manager 150, processing system 140, a radio, one or more RF chains, one or more transceivers, one or more antennas, one or more modems, a reception component (for example, reception component 1302 depicted and described in connection with FIG. 13), or a transmission component (for example, transmission component 1304 depicted and described in connection with FIG. 13), among other examples.

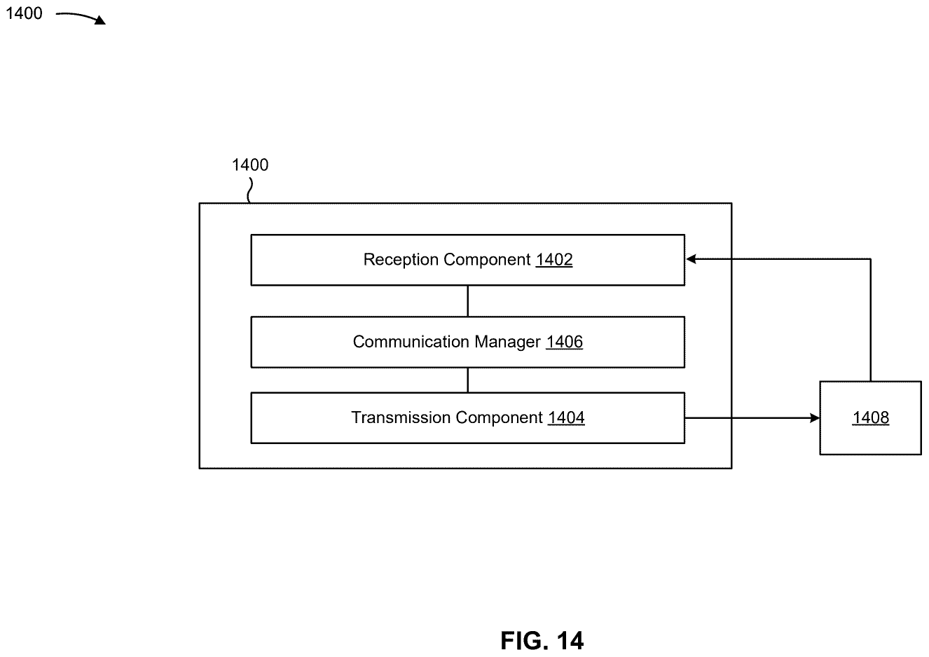

In some aspects, the network node 110 includes means for communicating, with the UE 120, a light sleep mode message indicating activation of a light sleep mode, wherein the light sleep mode includes a first reduced power state in which a main radio transceiver of the UE 120 is partially deactivated; or means for communicating with the UE 120 according to a deep sleep mode timer for triggering a deep sleep mode of the UE 120, wherein the deep sleep mode includes a second reduced power state in which the main radio transceiver of the UE 120 is more deactivated than in the light sleep mode. The means for the network node 110 to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

In some aspects, the network node 110 includes means for transmitting, to UE 120, a control channel message that schedules a communication between the UE 120 and the network node, wherein a new data indicator of the control channel message indicates that the communication includes a new communication; or means for communicating with the UE 120 while a timer that corresponds to the communication is activated. The means for the network node 110 to perform operations described herein may include, for example, one or more of communication manager 155, processing system 145, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

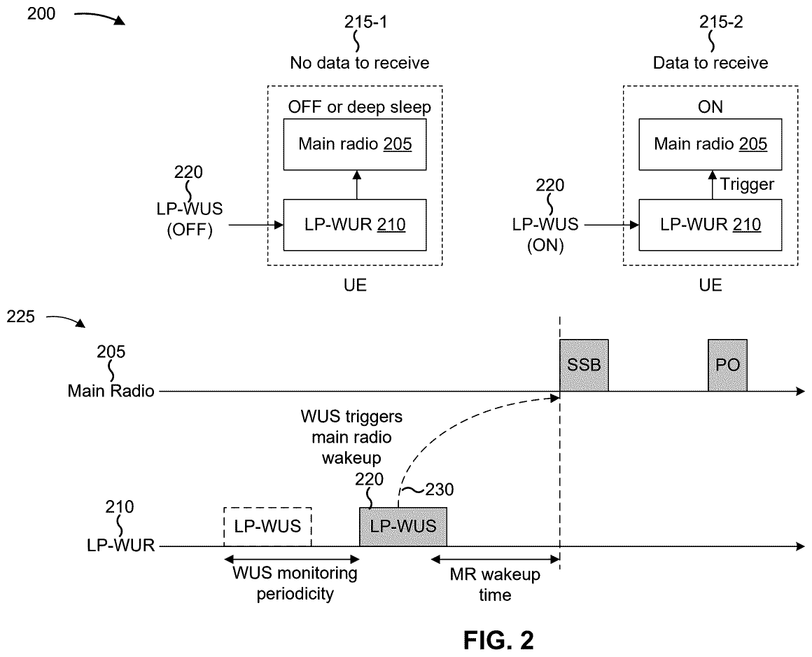

FIG. 2 is a diagram illustrating an example 200 of a low-power wake-up radio (LP-WUR) and a low-power wake-up signal (LP-WUS). As shown in FIG. 2, a UE (such as UE 120) may be equipped with a communication system that includes a main radio (illustrated as “MR”) 205 and an LP-WUR 210 to reduce power consumption and enable low latency. For example, power saving and low latency are often conflicting goals because placing one or more components into a sleep state more often to reduce power consumption also increases latency (e.g., because data cannot be transmitted or received while the one or more components are in the sleep state), and because reducing the time that one or more components spend in a sleep state to reduce latency can lead to increased power consumption. Accordingly, as shown in FIG. 2, the UE may be equipped with the LP-WUR 210, which may be considered a companion receiver that may be used with a main radio 205 to reduce power consumption and latency.

For example, in some aspects, the UE may generally use the main radio 205 to transmit or receive user data, and the main radio 205 may be turned off or operated in a deep sleep state unless there is user data to transmit or receive. Furthermore, the LP-WUR 210 may serve as a simple wake-up receiver for the main radio 205, and the LP-WUR 210 may be active and monitoring for an LP-WUS while the main radio 205 is off or in the deep sleep state. For example, reference number 215-1 depicts a first state associated with the main radio 205 and the LP-WUR 210 where there is no user data to be provided to the main radio 205. In such cases, the main radio 205 may be off or operated in the deep sleep state unless there is user data to transmit, and the LP-WUR 210 may monitor for an LP-WUS (for example, continuously, or periodically in monitoring occasions that are separated in time). Furthermore, reference number 215-2 depicts a second state associated with the main radio 205 and the LP-WUR 210 where there is user data for the main radio 205. In such cases, the LP-WUR 210 may receive an LP-WUS 220 (such as from a network node 110) and may provide a trigger to wake or otherwise activate the main radio 205 based on detecting the LP-WUS 220. Accordingly, the main radio 205 may then transmit or receive user data.

In general, the LP-WUR 210 may consume very little power (for example a target power consumption less than 100 microwatts (μW) in the active state), which may be achieved using simple modulation schemes (for example, on-off keying (OOK)), a narrow bandwidth (for example, less than 5 MHz), or other suitable techniques. In this way, the LP-WUR 210 may be used to reduce the time that the main radio 205 spends in an on state or may avoid unnecessarily waking the main radio 205 from the off or deep sleep state when there is no user data to transmit or receive, which tends to be costly from a power consumption perspective. Furthermore, because the LP-WUR 210 has a very low power consumption, the LP-WUR 210 may be used to frequently or continuously perform LP-WUS monitoring, which may improve latency because the main radio 205 may be woken up when there is user data that the main radio 205 needs to receive. For example, the LP-WUR 210 may not suffer from the latency versus power efficiency tradeoff associated with duty cycling schemes, such as DRX. Furthermore, in addition to performing LP-WUS monitoring, which may be used for paging reception, the LP-WUR 210 may monitor a low power synchronization signal (LP-SS) for time and frequency tracking and radio resource management (RRM) measurement. In this way, by monitoring the LP-SS, serving cell or neighbor cell monitoring may be offloaded from the main radio 205 to the LP-WUR 210 to reduce how often the main radio 205 is woken up, which may further reduce power consumption.

In some aspects, the LP-WUR 210 may include an OOK WUR (also referred to as an envelope detector (ED) WUR). An OOK WUR may only detect the amplitude (such as the magnitude) of a received signal. A UE that uses an OOK WUR may detect the phase of a received signal by activating the main radio 205.

In some aspects, the LP-WUR 210 may include an OFDM WUR (which may be referred to as an in-phase and quadrature (IQ) WUR). An OFDM WUR can detect both the amplitude and phase of a received signal. For example, an OFDM WUR can obtain first information that is modulated onto a signal using OOK modulation, and second information that is modulated onto the signal using phase modulation.

In some aspects, as shown by reference number 225, one application of the LP-WUR 210 is to monitor the LP-WUS 220 for paging monitoring, which can be used to reduce unnecessary paging reception performed by the main radio 205. For example, as shown in FIG. 2, the LP-WUR 210 may be configured to monitor for an LP-WUS 220 (while the main radio 205 is off or in a deep sleep state) according to a WUS monitoring periodicity. For example, the LP-WUR 210 may monitor for the LP-WUS 220 in periodic LP-WUS monitoring occasions that are spaced in time according to the WUS monitoring periodicity. Alternatively, although not explicitly shown in FIG. 2, the LP-WUR 210 may be configured to continuously monitor for the LP-WUS 220. In general, a network node may transmit an LP-WUS 220 to a UE only in cases where there is a paging message that needs to be sent to the UE while the UE is in an idle or inactive state (such as an RRC idle or RRC inactive state). In such cases, as shown by reference number 230, the LP-WUR 210 may receive and detect the LP-WUS 220, which may trigger the LP-WUR 210 to wake up the main radio 205. In some aspects, the LP-WUS 220 may be a sequence-based WUS, which may include a predefined set of sequences (implemented, for example, using OOK modulation or phase modulation). As shown, the main radio 205 may wake up after a main radio wake-up time, and may then start to monitor one or more synchronization signal block (SSB) transmissions to obtain synchronization with the network node before monitoring and receiving the paging message in a subsequent PO. Otherwise, in cases where the LP-WUR 210 does not detect the LP-WUS 220, the main radio 205 may remain in the deep sleep state to save power.

The time for the UE 120 to transition the main radio 205 out of the deep sleep mode may be significant and thus, entering a deep sleep mode may provide the most benefit during prolonged periods of inactivity to extend battery life. However, there may be scenarios in which a subsequent message is likely to occur after the communication of a burst of messages, and thus entering a deep sleep mode directly after receiving a burst of messages may increase latency.

As indicated above, FIG. 2 is provided as an example. Other examples may differ from what is described with respect to FIG. 2.

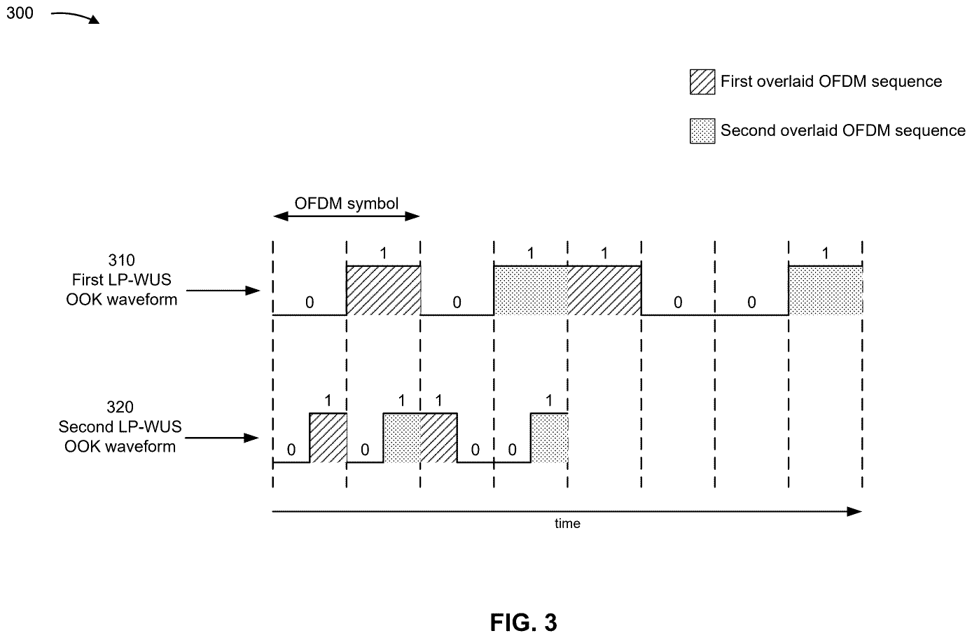

FIG. 3 is a diagram illustrating an example 300 of LP-WUS OOK waveforms.

An LP-WUS OOK waveform may be used to convey bits of information in the form of on and off durations. During an on duration, the LP-WUS OOK waveform may have a high amplitude or power that maps to a bit value of 1, and during an off duration, the LP-WUS OOK waveform may have a low or zero amplitude or power that maps to a bit value of 0. For example, in a base band, an LP-WUS OOK waveform may include a sequence of on durations and off durations. For FR1, 11 physical RBs (PRBs) may be allocated for an LP-WUS with a SCS of 30 kHz.

In some examples, an on duration of an LP-WUS OOK waveform may include one or more overlaid OFDM sequences that include one or more rapidly varying signals having the high amplitude or power that maps to the bit value of 1 (e.g., the overlaid OFDM sequence(s) may enable multiplexing by conveying information for another UE). An overlaid OFDM sequence may be a Gold sequence, an M sequence, a computer searched sequence, a Zadoff Chu sequence, or the like.

In some examples, LP-WUS OOK-1 waveforms or LP-WUS OOK-4 waveform may be supported for LP-WUS and LP-SS. An LP-WUS OOK-1 waveforms may convey one bit of information in one OFDM symbol (e.g., using an amplitude of the LP-WUS OOK-1 waveform). An LP-WUS OOK-4 waveform may convey N bits of information in one OFDM symbol (e.g., using an amplitude of the LP-WUS OOK-4 waveform).

Example 300 shows a first LP-WUS OOK waveform 310 and a second LP-WUS OOK waveform 310. The first LP-WUS OOK waveform 310 is an LP-WUS OOK-4 waveform with N=2 (e.g., the first LP-WUS OOK waveform 310 conveys two bits of information in one OFDM symbol). The second LP-WUS OOK waveform 320 is an LP-WUS OOK-4 waveform with N=4 (e.g., the second LP-WUS OOK waveform 320 conveys four bits of information in one OFDM symbol). As shown, the first LP-WUS OOK waveform 310 and the second LP-WUS OOK waveform 320 may each include multiple overlaid OFDM sequences in on durations.

The LP-WUR described with reference to FIG. 2 may be capable of receiving an OOK waveform but may not be enabled to communicate other types of messages. Thus, a UE in a deep sleep mode may miss one or more messages if the UE were to enter the deep sleep mode before transmission of the message. In some other examples, a message may be delayed if an OOK waveform is communicated before the message can be communicated. This may cause unnecessary delay in scenarios where a message is likely to be communicated (e.g., relatively soon after a burst of communications) but the UE has entered the deep sleep mode.

As indicated above, FIG. 3 is provided as an example. Other examples may differ from what is described with respect to FIG. 3.

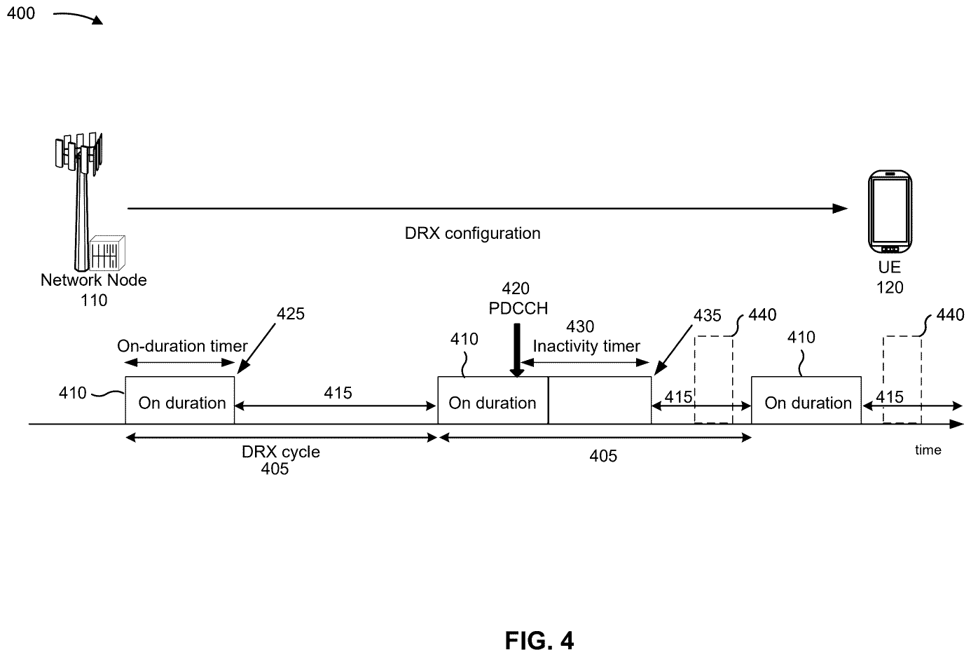

FIG. 4 is a diagram illustrating an example 400 of a discontinuous reception (DRX) configuration.

As shown in FIG. 4, a network node 110 may transmit a DRX configuration to a UE 120 to configure a DRX cycle 405 for the UE 120. A DRX cycle 405 may include a DRX on duration 410 (e.g., during which a UE 120 is awake or in an active state) and an opportunity to enter a DRX sleep state 415. As used herein, the time during which the UE 120 is configured to be in an active state during the DRX on duration 410 may be referred to as an active time, and the time during which the UE 120 is configured to be in the DRX sleep state 415 may be referred to as an inactive time. As described below, the UE 120 may monitor a physical downlink control channel (PDCCH) during the active time, and may refrain from monitoring the PDCCH during the inactive time.

During the DRX on duration 410 (e.g., the active time), the UE 120 may monitor a downlink control channel (e.g., a PDCCH), as shown by reference number 420. For example, the UE 120 may monitor the PDCCH for downlink control information (DCI) pertaining to the UE 120. When the UE 120 does not detect or successfully decode any PDCCH communications intended for the UE 120 during the DRX on duration 410, then the UE 120 may enter the sleep state 415 (e.g., for the inactive time) at the end of the DRX on duration 410, as shown by reference number 425. In this way, the UE 120 may conserve battery power and reduce power consumption. As shown, the DRX cycle 405 may repeat with a configured periodicity according to the DRX configuration.

If the UE 120 detects or successfully decodes a PDCCH communication intended for the UE 120, then the UE 120 may remain in an active state (e.g., awake) for the duration of a DRX inactivity timer 430 (e.g., which may extend the active time). The UE 120 may start the DRX inactivity timer 430 at a time at which the PDCCH communication is received (e.g., in a transmission time interval (TTI) in which the PDCCH communication is received, such as a slot or a subframe). The UE 120 may remain in the active state until the DRX inactivity timer 430 expires, at which time the UE 120 may enter the sleep state 415 (e.g., for the inactive time), as shown by reference number 435. During the duration of the DRX inactivity timer 430, the UE 120 may continue to monitor for PDCCH communications, may obtain a downlink data communication (e.g., on a downlink data channel, such as a physical downlink shared channel (PDSCH)) scheduled by the PDCCH communication, or may prepare or transmit an uplink communication (e.g., on a physical uplink shared channel (PUSCH)) scheduled by the PDCCH communication. The UE 120 may restart the DRX inactivity timer 430 after each detection of a PDCCH communication for the UE 120 for an initial transmission (e.g., but not for a retransmission). In some examples, the UE 120 may monitor for an LP-WUS during an LP-WUS monitoring occasion 440 outside of a C-DRX active time, according to an LP-WUS monitoring configuration (e.g., described in connection with FIGS. 2-3), to trigger PDCCH monitoring. By operating in this manner, the UE 120 may conserve battery power and reduce power consumption by entering the sleep state 415, and may reduce latency associated with communications from the network node 110 during a sleep state 415 by monitoring for an LP-WUS during LP-WUS monitoring occasions 440.

However, there may be examples, in the context of example 400, in which the UE 120 only has one communication, but the PDCCH granting the communication resources triggers the UE 120 to start the inactivity timer 430, which causes the UE 120 to remain in the active mode for a longer duration than useful for communicating the single communication. For example, the network node 110 may command the UE 120 to transmit a CSI report, but has no additional traffic to communicate, and the UE 120 may remain awake for a duration according to the inactivity timer 430, which may be defined such that two or more communications may be accommodated. Thus, the UE 120 may waste resources remaining in an active mode each time the inactivity timer 430 is initiated in response to a requested communication but there is no additional traffic to communicate.

As indicated above, FIG. 4 is provided as an example. Other examples may differ from what is described with respect to FIG. 4.

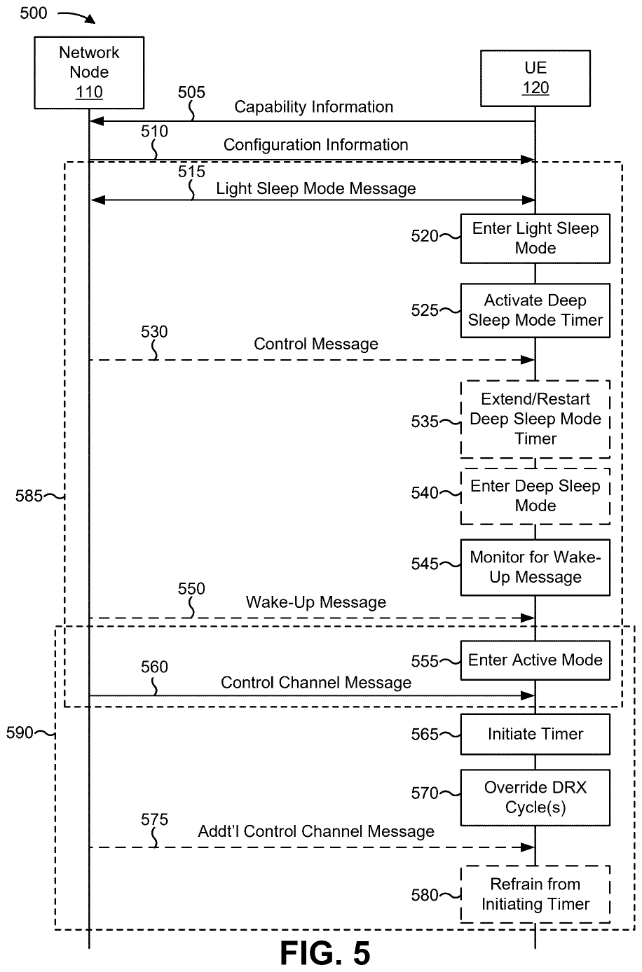

FIG. 5 is a diagram of an example 500 associated with timer-based sleep modes. As shown in FIG. 5, a network node 110 (e.g., a base station, a CU, a DU, or an RU) may communicate with a UE 120. In some aspects, the network node 110 and the UE 120 may be part of a wireless network (e.g., the wireless communication network 100). The UE 120 and the network node 110 may have established a wireless connection prior to operations shown in FIG. 5.

In some aspects, as shown by reference number 505, the UE 120 may transmit, and the network node 110 may receive, capability information. The capability information may be included in a capability report. The UE 120 may transmit the capability information via an uplink communication, a sidelink communication, a unicast communication, a broadcast communication, a UE assistance information (UAI) communication, an uplink control information (UCI) communication, a sidelink control information (SCI) communication, a MAC control element (MAC-CE) communication, an RRC communication, a physical uplink control channel (PUCCH), a physical uplink shared channel (PUSCH), a physical sidelink control channel (PSCCH), or a physical sidelink shared channel (PSSCH), among other examples. The capability information may indicate one or more parameters associated with respective capabilities of the UE 120. The one or more parameters may be indicated via respective information elements (IEs) included in a capability report.

The capability information may indicate whether the UE 120 supports a feature or one or more parameters related to the feature. For example, the capability information may indicate a capability or parameter for timer-based sleep modes. As another example, the capability information may indicate a capability or parameter for performing operations according to a deep sleep mode timer. As another example, the capability information may indicate a capability or parameter for performing operations according to one or more message-specific inactivity timers. One or more operations described herein may be based on capability information. For example, the UE 120 may perform a communication in accordance with the capability information, or may receive configuration information that is in accordance with the capability information. In some aspects, the capability information may indicate UE support for a light sleep mode or for overriding one or more DRX cycles.

As shown by reference number 510, the network node 110 may transmit, and the UE 120 may receive, configuration information. In some aspects, the UE 120 may receive the configuration information via one or more of system information signaling (e.g., a master information block (MIB) or a system information block (SIB), among other examples), RRC signaling, MAC signaling (e.g., one or more MAC-CEs), or physical layer signaling (e.g., DCI), among other examples.

In some aspects, the configuration information may indicate one or more candidate configurations or communication parameters. In some aspects, the one or more candidate configurations or communication parameters may be selected, activated, or deactivated by a subsequent indication. For example, the subsequent indication may select a candidate configuration or communication parameter from the one or more candidate configurations or communication parameters. In some aspects, the subsequent indication may include a dynamic indication, such as one or more MAC CEs or one or more DCI messages, among other examples.

In some aspects, the configuration information may include an indication of a selection of one or more configuration parameters (e.g., a selection of the one or more configuration parameters already known to the UE 120 or previously indicated by the network node or other network device), or explicit configuration information for the UE 120 to use to configure the UE 120, among other examples.

In some examples, the configuration information may not be expressly signaled to the UE 120. For example, in some aspects, the configuration information may at least partially be defined by a wireless communication standard, such as the 3GPP. In such examples, the network node 110 may not explicitly indicate such configuration information to the UE 120. For example, the UE 120 may optionally obtain at least a portion of the configuration information from a configuration stored by the UE 120 (e.g., an original equipment manufacturer (OEM) configuration). In some aspects, the configuration information may include a parameter or index that is indicative of information defined, or otherwise fixed, by a wireless communication standard, such as the 3GPP (e.g., rather than explicitly indicating the information).

In some aspects, the configuration information may include an LP-WUS configuration, or a DRX configuration, or both. In some aspects, the configuration information may indicate that the UE 120 is to implement aspects of a DRX configuration in conjunction with or at the same time or during overlapping times as an LP-WUS configuration. In some aspects, the configuration information may indicate one or more timers for implementing sleep modes as part of the LP-WUS configuration or the DRX configuration, or both. In some aspects, the configuration information may indicate a duration of a deep sleep timer associated with a deep sleep mode. In some aspects, the configuration information may include a network communication schedule, where a duration of the deep sleep mode timer may be selected in accordance with a period of expected network inactivity indicated by the network communication schedule. In some aspects, the duration of the deep sleep mode timer may correspond to a discontinuous reception cycle of the UE 120.

The UE 120 may configure itself based at least in part on the configuration information. In some aspects, the UE 120 may be configured to perform one or more operations described herein based at least in part on the configuration information.

As shown by reference number 515, the UE 120 and the network node 110 may communicate a light sleep mode message. For example, the network node 110 and the UE 120 may communicate a light sleep mode message indicating activation of a light sleep mode. In such aspects, the light sleep mode may include a first reduced power state in which a main radio transceiver of the UE 120 is partially deactivated.

In some aspects, communicating the light sleep mode message may include the network node 110 transmitting, and the UE 120 receiving, a light sleep mode command. For example, the UE 120 may receive an indication from the network that indicates that the UE 120 is to enter a light sleep mode, or is to implement one or more aspects related to a sleep mode, such as a light sleep mode timer for entering the light sleep mode, or a deep sleep mode timer for transitioning to the deep sleep mode. In some aspects, communicating the light sleep mode message may include the UE 120 transmitting, to the network 110 node, the light sleep mode message, and the UE 120 receiving an acknowledgment message in response to the light sleep mode message. In such aspects, entering the light sleep mode (e.g., described in connection with reference number 520) may occur after or in response to receiving the acknowledgement message. In some aspects, communicating the light sleep mode message is in accordance with an expiry of a light sleep mode timer. For example, based on one or more triggering conditions, such as a communicated message or an indication from the network node 110, the UE 120 may initiate a light sleep mode timer that, when expired, triggers the UE to transition into the light sleep mode.

As shown by reference number 520, the UE 120 may enter the light sleep mode. For example, the UE 120 may enter the light sleep mode in accordance with communicating the light sleep mode indication described in connection with reference number 515. In some aspects, entering the light sleep mode may be triggered by an expiry of an inactivity timer. In some aspects, the main radio transceiver of the UE 120, while in the light sleep mode, may be capable of processing a subset of signals associated with communications in an active mode.

As shown by reference number 525, the UE 120 may activate the deep sleep mode timer. For example, the UE may activate the deep sleep mode timer for entering a deep sleep mode in accordance with activating the light sleep mode described in connection with reference number 520. In such aspects, the deep sleep mode may include a second reduced power state in which the main radio transceiver of the UE 120 is less activated or more deactivated than in the light sleep mode. For example, one or more components or functionalities of the main radio transceiver may be disabled or deactivated in the deep sleep mode than are enabled or activated in the light sleep mode. In some aspects, a duration of the deep sleep mode timer may correspond to a DRX cycle of the UE 120.

As shown by reference number 530, in some aspects, the network node 110 may transmit, and the UE 120 may receive, a control message. For example, the UE 120 may receive a control message indicating a duration of the deep sleep mode timer. In some aspects, the UE may receive a network communication schedule. In such aspects, a duration of the deep sleep mode timer may be selected in accordance with a period of expected network inactivity indicated by the network communication schedule. In some aspects, the UE may receive a control message indicating a future network communication.

As shown by reference number 535, in some aspects, the UE 120 may extend or restart the deep sleep mode timer. For example, the UE 120 may extend a duration of the deep sleep mode timer or may add an additional duration to an active duration of the deep sleep mode timer. In some other aspects, the deep sleep mode timer may be restarted in accordance with one or more network communication conditions being satisfied. In some aspects, the UE 120 may extend a duration of the deep sleep mode timer in accordance with receiving the control message indicating the future network communication described in connection with reference number 530. In some aspects, the UE 120 may restart the deep sleep mode timer in accordance with receiving the control message indicating the future network communication described in connection with reference number 530.

As shown by reference number 540, in some aspects, the UE 120 may enter the deep sleep mode. In some aspects, the UE 120 may transition from the light sleep mode to the deep sleep mode upon expiration of the deep sleep mode timer. In some aspects, the UE 120 may deactivate the main radio transceiver of the UE 120 in association with an expiry of the deep sleep mode timer, for example, in accordance with entering the deep sleep mode. In such aspects, deactivating the main radio transceiver may cause a greater quantity of components of the main radio transceiver to be deactivated, as compared to a quantity of deactivated components of the main radio transceiver in the light sleep mode described in connection with reference number 520. In some aspects, the main radio transceiver of the UE 120, while in the deep sleep mode, may be capable of processing a subset of signals associated with communications in the light sleep mode. For example, the main radio transceiver of the UE 120, while in the light sleep mode, may be capable of processing a first subset of signals associated with communications in the active mode and, while in the deep sleep mode, may be capable of processing a second subset of signals associated with communications in the active mode. In some aspects, the second subset is a subset of the first subset. For example, the main radio transceiver of the UE 120 may be capable of processing fewer types of messages while in the deep sleep mode than while in the light sleep mode. As another example, one or more components or functionalities enabled or activated in the active mode may be disabled in the light sleep mode and one or more additional components or functionalities that are enabled or activated in the active mode and the light sleep mode may be disabled in the deep sleep mode.

As shown by reference number 545, the UE 120 may monitor for a wake-up message. For example, the UE 120 may monitor for a wake-up signal using a low-power wake-up radio when the UE 120 is operating according to at least one of the light sleep mode described in connection with reference number 520 or the deep sleep mode described in connection with reference number 540.

As shown by reference number 550, in some aspects, the network node 110 may transmit, and the UE 120 may receive, a wake-up message. For example, the network node 110 may transmit, and the UE 120 may receive, while the deep sleep mode timer is activated, a message prompting the UE to wake up. For example, the message may instruct, command, trigger, or indicate that the UE 120 is to wake up (e.g., activate one or more features of the main radio, or transition to a mode in which one or more components of the main radio are activated, or transition into a wake mode or an active mode). In some aspects, the message may include a wake-up signal, a scheduling message, a PDCCH, or a CSI report request. In some aspects, the network node 110 may transmit, and the UE 120 may receive, using the main radio transceiver that is partially deactivated, a wake-up signal. In such aspects, the wake-up signal prompts the UE 120 to transition to an active mode from the light sleep mode described in connection with reference number 520. In some aspects, the network node 110 may transmit, and the UE 120 may receive, a wake-up signal. In such aspects, the wake-up signal prompts the UE 120 to transition to an active mode from the light sleep mode described in connection with reference number 520 or to the light sleep mode from the deep sleep mode described in connection with reference number 540. In some aspects,, the wake-up signal may include an on-off keying signal.

As shown by reference number 555, in some aspects, the UE 120 may enter the active mode. For example, the UE 120 may enter the active mode in accordance with receiving the message described in connection with reference number 550. In such aspects, the active mode may include a full power state in which the main radio transceiver of the UE 120 is fully activated. In some aspects, the UE 120 may wake up from the deep sleep mode in response to the wake-up message or signal from the network node 110 described in connection with reference number 550. In such aspects, the wake-up signal may prompt activation of the main radio transceiver. For example, the UE 120 may activate one or more components or capabilities of the main radio transceiver in response to the wake-up signal. In some aspects, the wake-up signal may trigger activation of the main radio transceiver. In some aspects, a first ramp-up time for transitioning from the light sleep mode to the active mode is shorter than a second ramp-up time for transitioning from the deep sleep mode to the active mode. In some aspects, the UE 120 may receive a wake-up signal as described in connection with reference number 550, and may activate the main radio transceiver from being partially deactivated to fully activated, for example, in accordance with entering the active mode.

As shown by reference number 560, the network node 110 may transmit, and the UE 120 may receive, a control channel message. For example, the UE 120 may receive, from the network node 110, a control channel message (e.g., a PDCCH) that schedules a communication between the UE 120 and the network node 110. In such aspects, a new data indicator of the control channel message may indicate that the communication includes a new communication.

In some aspects, the network node 110 may transmit, and the UE 120 may receive, while operating according to at least one of the light sleep mode or the deep sleep mode, a message prompting the UE 120 to transition to an active mode, and a control channel message. For example, the network node 110 may transmit, and the UE 120 may receive, the control channel message according to or after a first minimum time offset for transitioning from the light sleep mode to the active mode. In another example, the network node 110 may transmit, and the UE 120 may receive, the control channel message according to or after a second minimum time offset for transitioning from the deep sleep mode to the active mode. The first minimum time offset and the second minimum time offset may each define a duration between receiving the message described in connection with reference number 550 and a time after which the main radio transceiver is capable of receiving the control channel message described in connection with reference number 560. In some aspects, the first minimum time offset may be shorter than the second minimum time offset.

As shown by reference number 565, the UE 120 may initiate a timer. For example, the UE 120 may initiate a timer in reaction to receiving the control channel message described in connection with reference number 560. In some aspects, the UE 120 may initiate the timer in accordance with the new data indicator of the control channel message indicating that the communication includes a new downlink communication. For example, an inactivity timer may be started, in some aspects, only when a PDCCH message schedules a new transmission. Thus, an inactivity timer may be initiated according to a DCI format indicator (e.g., indicating a type of message such that the initiated timer corresponds to the message) or in response to receiving a new data indicator in a PDCCH message. In some aspects, the control channel message described in connection with reference number 560 may explicitly indicate that the UE 120 is to initiate the timer, for example, where the initiated timer corresponds to an indicated message type (e.g., uplink, downlink). In some aspects, the control channel message, described in connection with reference number 560, may schedule a plurality of communications and the timer may include a general inactivity timer (e.g., drx-InactivityTimer). In some aspects, the control channel message, described in connection with reference number 560, may schedule a single communication and the timer may include a shortened inactivity timer (e.g., an inactivity timer that is shorter in duration than a general inactivity timer (e.g., drx-InactivityTimer).

In some aspects, the UE 120 may initiate the timer in accordance with the control channel message being scrambled with a radio network temporary identifier that triggers initiation of the timer. For example, the UE 120 may start an inactivity timer when a PDCCH message is scrambled with a certain radio network temporary identifier (RNTI). There are many different RNTIs (e.g., cell RNTI (C-RNTI), configured scheduling RNTI, interruption RNTI, paging RNTI, system information RNTI, semi-persistent CSI RNTI, slot format indication RNTI, transmit power control PUCCH RNTI, transmit power control PUSCH RNTI, transmit power control SRS RNTI, random access RNTI, temporary C-RNTI, inactive RNTI), and a subset may trigger the UE 120 to initiate the inactivity timer.

In such aspects, the timer may correspond to the communication. For example, a duration of the timer may correspond to a quantity of scheduled communications, or may depend on a type of the communication. In aspects where the control channel message schedules a downlink communication, the timer may include a downlink inactivity timer (e.g., drx-InactivityTimerDL). In such aspects, the duration of the downlink inactivity timer may be shorter than a duration of a general inactivity timer (e.g., drx-InactivityTimer). In aspects where the control channel message schedules an uplink communication, the timer may include an uplink inactivity timer (e.g., drx-InactivityTimerUL). In such aspects, the duration of the uplink inactivity timer may be shorter than a duration of a general inactivity timer (e.g., drx-InactivityTimer).

As shown by reference number 570, the UE 120 may override one or more DRX cycles. For example, the UE 120 may override one or more DRX cycles for a duration of the timer according to a wake mode of the UE 120. For example, the UE 120 may remain awake during one or more scheduled on durations of a DRX cycle.

As shown by reference number 575, the network node 110 may transmit, and the UE 120 may receive, an additional control channel message. For example, the network node 110 may transmit, and the UE 120 may receive, an additional control channel message that schedules a single communication.

As shown by reference number 580, in some aspects, the UE 120 may refrain from initiating a timer. For example, the UE 120 may refrain from initiating the timer in association with communicating the single communication (e.g., scheduled by the additional control channel message described in connection with reference number 575). In such aspects, the UE 120 may conserve power by returning to operating according to the DRX cycles instead of remaining in the wake mode when only a single message is scheduled.

As shown by reference number 585, reference numbers 515-560, whether in combination with or independently from reference number 505 or reference number 510 or both, may illustrate a first example of timer-based sleep modes. As shown by reference number 590, reference numbers 555-580, whether in combination with or independently from reference number 505 or reference number 510 or both, may illustrate a second example of timer-based sleep modes. Aspects of the first example and aspects of the second example may be implemented together or independently from one another. For example, the UE 120 and the network node 110 may implement only aspects of the first example, only aspects of the second example, or may implement aspects of the first example and aspects of the second example.

As indicated above, FIG. 5 is provided as an example. Other examples may differ from what is described with respect to FIG. 5.

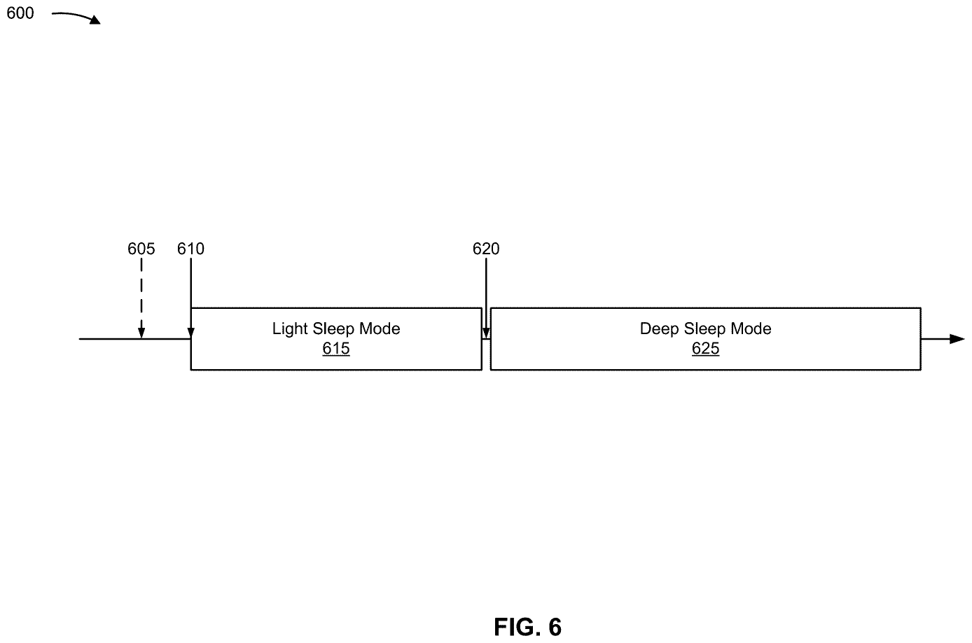

FIG. 6 is a diagram illustrating an example 600 associated with a light sleep mode and a deep sleep mode timer, in accordance with the present disclosure. As shown by FIG. 6, a UE may transition between different sleep modes to manage power consumption.

As shown by reference number 605, the UE may communicate a light sleep mode message indicating activation of a light sleep mode. For example, the UE may communicate with a network node to signal that the UE is entering a first reduced power state where the main radio transceiver of the UE is partially deactivated. In some aspects, communicating the light sleep mode message may include transmitting, to the network node, the light sleep mode message and receiving an acknowledgment message in response to the light sleep mode message, wherein entering the light sleep mode occurs after receiving the acknowledgment message. For instance, the UE may send the message to the network node and await confirmation before entering the reduced power state to support proper synchronization. Additionally, or alternatively, communicating the light sleep mode message may include receiving, from the network node, a light sleep mode command. For example, the network node may instruct the UE to enter the light sleep mode based on network activity or conditions.

As further shown by reference number 610, the UE may activate a deep sleep mode timer for entering a deep sleep mode. For example, the UE may start the deep sleep mode timer upon entering the light sleep mode, indicating the duration that the UE will remain in the light sleep mode before transitioning to a deeper sleep state when no subsequent communication is received. In some aspects, activating the deep sleep mode timer may include receiving a control message indicating a duration of the deep sleep mode timer. For instance, the network node may send a control message specifying how long the deep sleep mode timer should run before the UE transitions to the deep sleep mode. Additionally, or alternatively, activating the deep sleep mode timer may include receiving a network communication schedule, wherein a duration of the deep sleep mode timer is selected in accordance with a period of expected network inactivity indicated by the network communication schedule. For example, the UE may adjust the deep sleep mode timer based on a schedule that predicts when the network will be inactive.

As further shown by reference number 615, the UE may enter the light sleep mode. In this mode, the UE's main radio transceiver is partially deactivated, allowing for quicker wake-up times and reduced latency while conserving some power. In some aspects, entering the light sleep mode may be triggered by an expiry of an inactivity timer. For instance, the UE may enter the light sleep mode after detecting a period of inactivity. Additionally, or alternatively, entering the light sleep mode may include the main radio transceiver being capable of processing a subset of signals associated with communications in an active mode. For example, the UE may still handle essential signals even while in the light sleep mode, to maintain minimal communication.

As further shown by reference number 620, upon the expiration of the deep sleep mode timer, the UE may transition from the light sleep mode to the deep sleep mode. For example, the UE may enter the deep sleep mode when no wake-up signal or other command is received from the network during the light sleep mode duration. In some aspects, transitioning from the light sleep mode to the deep sleep mode may include deactivating the main radio transceiver of the UE, wherein deactivating the main radio transceiver causes a greater quantity of components of the main radio transceiver to be deactivated as compared to (e.g., more deactivated than) a quantity of deactivated components of the main radio transceiver in the light sleep mode. For instance, the main radio transceiver may be more deactivated or less activated when a greater quantity of components or functionalities of the main radio transceiver are deactivated than in another mode. As a result, the UE may power down more components of the main radio transceiver to achieve greater power savings.

As further shown by reference number 625, the UE may operate in the deep sleep mode following the expiration of the deep sleep mode timer. In this mode, the main radio transceiver of the UE is more deactivated than in the light sleep mode, resulting in greater power savings but requiring a longer time to wake up and resume full operation. In some aspects, operating in the deep sleep mode may include the main radio transceiver being capable of processing a subset of signals associated with communications in the light sleep mode. For example, while in deep sleep mode, the UE may still handle some signals to maintain minimal connectivity, such as an LP-WUS.

As indicated above, FIG. 6 is provided as an example. Other examples may differ from what is described with respect to FIG. 6.

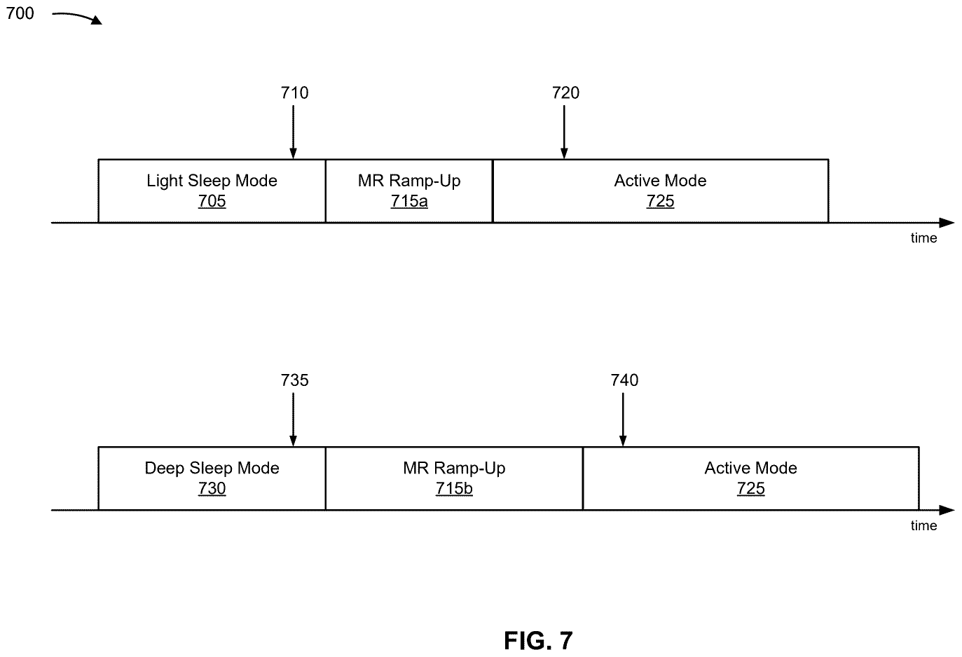

FIG. 7 is a diagram illustrating an example 700 associated with ramp-up times for transitioning to an active mode, in accordance with the present disclosure.

As shown in FIG. 7, and reference number 700, a UE may manage its power consumption by transitioning between different sleep modes and active modes based on received signals and timers.

As further shown by reference number 705, the UE may enter a light sleep mode. In the light sleep mode, the main radio transceiver of the UE may be partially deactivated, allowing the UE to conserve power while remaining capable of quick activation. For example, the light sleep mode may be initiated based on a network indication, a UE decision, or an inactivity timer expiration, and the UE may start a timer upon entering the light sleep mode. In one example, the UE may not detect any activity for a period of time, triggering the inactivity timer and consequently the light sleep mode.

As further shown by reference number 710, the UE may receive an LP-WUS. The LP-WUS may be transmitted by a network node and received by the UE using an LP-WUR. Upon detecting the LP-WUS, the UE may initiate a ramp-up process or remain in the light sleep mode, depending on the received signal. For instance, the LP-WUS may include specific instructions that determine whether the UE should begin ramping up or continue conserving power.

As further shown by reference number 715a, the main radio transceiver of the UE 120 may undergo a ramp-up process. The ramp-up process involves activating the main radio transceiver from its partially deactivated state in the light sleep mode to a fully activated state. This process allows the UE to prepare for receiving control signals from the network or to transition to an active mode. For example, the ramp-up process may help the main radio transceiver handle incoming data or manage network interactions effectively.

As further shown by reference number 720, the UE may receive a PDCCH message from the network node. The PDCCH message may include control information, such as scheduling information for subsequent data transmissions or instructions to maintain the current state. For instance, the PDCCH message may indicate that the UE is to prepare for an upcoming data transfer or to continue operating in a current mode for optimized performance.

As further shown by reference number 725, the UE may enter an active mode. In the active mode, the main radio transceiver of the UE is fully activated, enabling the UE to perform necessary communications, such as receiving or transmitting data, responding to control signals, or performing network measurements.

As further shown by reference number 730, the UE may enter a deep sleep mode. When the UE does not receive any wake-up signals or commands during the light sleep mode, the UE may transition to a deeper sleep state for greater power savings. In the deep sleep mode, the main radio transceiver of the UE is more deactivated compared to the light sleep mode, resulting in longer ramp-up times but significant energy savings. The UE may implement the deep sleep mode during prolonged periods of inactivity to extend battery life.

As further shown by reference number 735, the UE may receive an LP-WUS while in the deep sleep mode. In such aspects, the LP-WUS prompts the UE to initiate a ramp-up process or transition to a light sleep mode. For example, the UE may receive an LP-WUS indicating that the UE 120 is to prepare to re-engage with the network, and may ramp-up the main radio transceiver from a low power state (e.g., a sleep mode), such as the deep sleep mode.

As further shown by reference number 715b, the main radio transceiver of the UE undergoes a ramp-up process from the deep sleep mode. This process takes longer compared to the ramp-up from the light sleep mode due to the greater deactivation of components in the deep sleep mode. Thus it may be beneficial to enter a light sleep mode when there is a likelihood of the UE 120 being sent a message while in a sleep cycle or a sleep mode.

As further shown by reference number 740, the UE may receive a PDCCH message after the ramp-up process from the deep sleep mode. The PDCCH message may trigger the UE to transition back to the active mode to perform communications, or to a light sleep mode in anticipation of a potential communication depending on network instructions.

As indicated above, FIG. 7 is provided as an example. Other examples may differ from what is described with respect to FIG. 7.

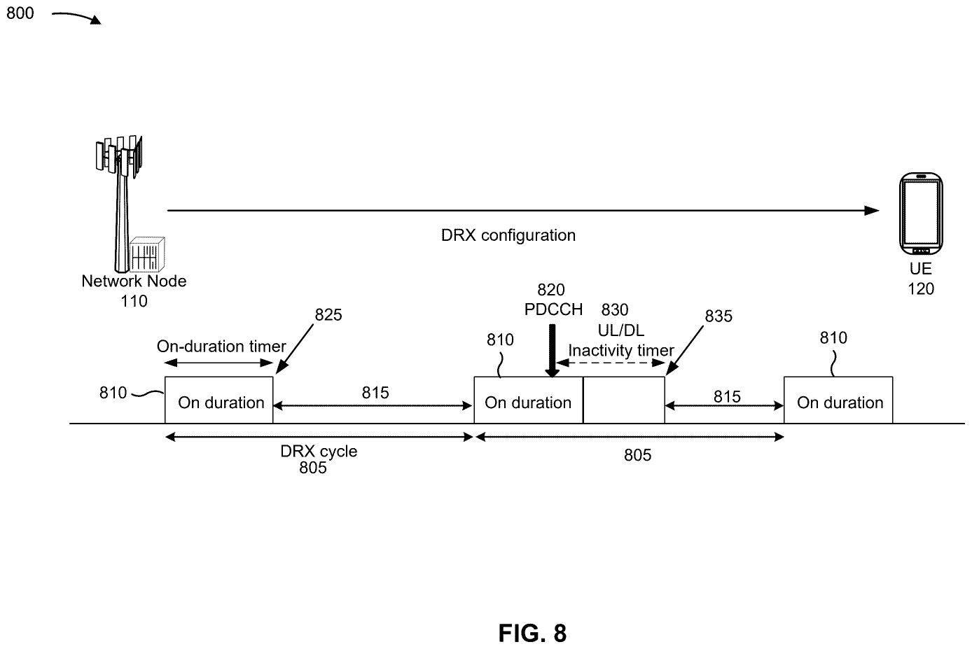

FIG. 8 is a diagram illustrating an example 800 of timers for a DRX configuration. As shown in FIG. 8, a network node 110 may transmit a DRX configuration to a UE 120 to configure a DRX cycle 805 for the UE 120. A DRX cycle 805 may include a DRX on duration 810 (e.g., during which a UE 120 is awake or in an active state) and an opportunity to enter a DRX sleep state 815. As used herein, the time during which the UE 120 is configured to be in an active state during the DRX on duration 810 may be referred to as an active time, and the time during which the UE 120 is configured to be in the DRX sleep state 815 may be referred to as an inactive time. As described below, the UE 120 may monitor a PDCCH during the active time, and may refrain from monitoring the PDCCH during the inactive time.

During the DRX on duration 810 (e.g., the active time), the UE 120 may monitor a PDCCH 820. For example, the UE 120 may monitor the PDCCH for downlink control information (DCI) pertaining to the UE 120. When the UE 120 does not detect or successfully decode any PDCCH communications intended for the UE 120 during the DRX on duration 810, then the UE 120 may enter the sleep state 815 (e.g., for the inactive time) at the end of the DRX on duration 810, as shown by reference number 825. In this way, the UE 120 may conserve battery power and reduce power consumption. As shown, the DRX cycle 805 may repeat with a configured periodicity according to the DRX configuration.

If the UE 120 detects or successfully decodes a PDCCH communication intended for the UE 120, then the UE 120 may remain in an active state (e.g., awake) for the duration of a DRX inactivity timer 830 (e.g., which may extend the active time). The UE 120 may start the DRX inactivity timer 830 at a time at which the PDCCH communication is received (e.g., in a transmission time interval (TTI) in which the PDCCH communication is received, such as a slot or a subframe). The UE 120 may remain in the active state until the DRX inactivity timer 830 expires, at which time the UE 120 may enter the sleep state 815 (e.g., for the inactive time), as shown by reference number 835. During the duration of the DRX inactivity timer 830, the UE 120 may continue to monitor for PDCCH communications, may obtain a downlink data communication (e.g., on a downlink data channel, such as a physical downlink shared channel (PDSCH)) scheduled by the PDCCH communication, or may prepare or transmit an uplink communication (e.g., on a physical uplink shared channel (PUSCH)) scheduled by the PDCCH communication. The UE 120 may restart the DRX inactivity timer 830 after each detection of a PDCCH communication for the UE 120 for an initial transmission (e.g., but not for a retransmission). By operating in this manner, the UE 120 may conserve battery power and reduce power consumption by entering the sleep state 815.

In some aspects, the UE 120 may only have a single transmission at a point where the inactivity timer 830 would be triggered, but because the PDCCH 820 granting uplink resources triggers the UE 120 to start the inactivity timer, the UE 120 may be caused to remain awake unnecessarily. For example, the network node 110 may transmit a command to the UE 120 instructing the UE 120 to transmit a CSI report without having any further downlink or uplink traffic to serve. In such examples, the UE 120 stays awake due to the inactivity timer 830 being started, leading to inefficient power usage. By refining the conditions under which the inactivity timer is started, or redefining additional or alternative inactivity timers 830, the UE 120 may optimize power consumption and improve overall efficiency.

In various implementations, different inactivity timers 830 may be configured for different types of new transmissions, and an inactivity timer 830 corresponding to the indicated new transmission may be initiated. For instance, the UE 120 may be configured with separate timers such as drx-InactivityTimerDL and drx-InactivityTimerUL. The drx-InactivityTimerDL may be initiated when the PDCCH 820 indicates a new downlink transmission, whereas the drx-InactivityTimerUL may be started when the PDCCH 820 indicates a new uplink transmission. This differentiation allows the UE 120 to manage power consumption more effectively by tailoring the inactivity periods to the specific type of transmission.

The PDCCH 820 may schedule a new downlink or uplink transmission, and may include a DCI in formats such as 1_0 or 1_1 for downlink communications and 0_0 or 0_1 for uplink communications. In such aspects, a new data indicator within the DCI may signal that a new transmission is scheduled. In some aspects, an existing inactivity timer 830 may be started, for example, only when the PDCCH 820 indicates either a new downlink transmission or a new uplink transmission, based on the DCI format indicator or the new data indicator in the PDCCH 820. This approach supports UE power-saving by initiating the inactivity timer when necessary, thereby conserving power (e.g., rather than remaining in a wake mode according to the inactivity timer when no new messages are scheduled).

In some scenarios, the inactivity timer may be started when the PDCCH 820 indicating a new downlink or uplink transmission contains an explicit indication to start the inactivity timer 830. For example, a DCI within the PDCCH may include an explicit indication to start the inactivity timer 830. Additionally or alternatively, the inactivity timer 830 may be started when the PDCCH 820 is scrambled with certain RNTIs. For example, there may be various RNTIs, but only a subset of all RNTIs may trigger the inactivity timer. Thus, a new technique for initiating or refraining from initiating the inactivity timer may be supported without additional overhead that would otherwise be used to transmit an explicit indication. As a result, the UE 120 may decrease an amount of time staying awake, especially when no additional message is expected.

As indicated above, FIG. 8 is provided as an example. Other examples may differ from what is described with respect to FIG. 8.

FIG. 9 is a diagram illustrating an example process 900 performed, for example, at a UE or an apparatus of a UE. Example process 900 is an example where the apparatus or the UE (e.g., UE 120) performs operations associated with timer-based sleep modes.

As shown in FIG. 9, in some aspects, process 900 may include communicating, with a network node, a light sleep mode message indicating activation of a light sleep mode, wherein the light sleep mode includes a first reduced power state in which a main radio transceiver of the UE is partially deactivated (block 910). For example, the UE (e.g., using reception component 1302, transmission component 1304, or communication manager 1306, depicted in FIG. 13) may communicate, with a network node, a light sleep mode message indicating activation of a light sleep mode, wherein the light sleep mode includes a first reduced power state in which a main radio transceiver of the UE is partially deactivated, as described above.

As further shown in FIG. 9, in some aspects, process 900 may include entering the light sleep mode in accordance with communicating the light sleep mode indication (block 920). For example, the UE (e.g., using communication manager 1306, depicted in FIG. 13) may enter the light sleep mode in accordance with communicating the light sleep mode indication, as described above.

As further shown in FIG. 9, in some aspects, process 900 may include activating a deep sleep mode timer for entering a deep sleep mode in accordance with activating the light sleep mode, wherein the deep sleep mode includes a second reduced power state in which the main radio transceiver of the UE is more deactivated than in the light sleep mode (block 930). For example, the UE (e.g., using communication manager 1306, depicted in FIG. 13) may activate a deep sleep mode timer for entering a deep sleep mode in accordance with activating the light sleep mode, wherein the deep sleep mode includes a second reduced power state in which the main radio transceiver of the UE is more deactivated than in the light sleep mode, as described above.

Process 900 may include additional aspects, such as any single aspect or any combination of aspects described below or in connection with one or more other processes described elsewhere herein.

In a first aspect, process 900 includes transitioning from the light sleep mode to the deep sleep mode upon expiration of the deep sleep mode timer.

In a second aspect, alone or in combination with the first aspect, process 900 includes waking up from the deep sleep mode in response to a wake-up signal from the network node, wherein the wake-up signal prompts activation of the main radio transceiver.

In a third aspect, alone or in combination with one or more of the first and second aspects, process 900 includes receiving, from the network node while the deep sleep mode timer is activated, a message prompting the UE to wake up, and entering an active mode in accordance with receiving the message, wherein the active mode includes a full power state in which the main radio transceiver of the UE is fully activated.

In a fourth aspect, alone or in combination with one or more of the first through third aspects, the message includes at least one of a wake-up signal, a scheduling message, a physical downlink control channel message, or a channel state information report request.

In a fifth aspect, alone or in combination with one or more of the first through fourth aspects, process 900 includes receiving, using the main radio transceiver that is partially deactivated, a wake-up signal, wherein the wake-up signal prompts the UE to transition to an active mode from the light sleep mode.

In a sixth aspect, alone or in combination with one or more of the first through fifth aspects, process 900 includes receiving, using a low-power wake-up radio, a wake-up signal, wherein the wake-up signal prompts the UE to transition to an active mode from the light sleep mode or to the light sleep mode from the deep sleep mode.

In a seventh aspect, alone or in combination with one or more of the first through sixth aspects, the wake-up signal includes an on-off keying signal.

In an eighth aspect, alone or in combination with one or more of the first through seventh aspects, a first ramp-up time for transitioning from the light sleep mode to an active mode is shorter than a second ramp-up time for transitioning from the deep sleep mode to the active mode.

In a ninth aspect, alone or in combination with one or more of the first through eighth aspects, the deep sleep mode timer is restarted in accordance with one or more network communication conditions being satisfied.

In a tenth aspect, alone or in combination with one or more of the first through ninth aspects, process 900 includes receiving a control message indicating a duration of the deep sleep mode timer.

In an eleventh aspect, alone or in combination with one or more of the first through tenth aspects, process 900 includes receiving a network communication schedule, wherein a duration of the deep sleep mode timer is selected in accordance with a period of expected network inactivity indicated by the network communication schedule.

In a twelfth aspect, alone or in combination with one or more of the first through eleventh aspects, a duration of the deep sleep mode timer corresponds to a discontinuous reception cycle of the UE.

In a thirteenth aspect, alone or in combination with one or more of the first through twelfth aspects, process 900 includes receiving a control message indicating a future network communication.

In a fourteenth aspect, alone or in combination with one or more of the first through thirteenth aspects, process 900 includes extending a duration of the deep sleep mode timer in accordance with receiving the control message.

In a fifteenth aspect, alone or in combination with one or more of the first through fourteenth aspects, process 900 includes restarting the deep sleep mode timer in accordance with receiving the control message.

In a sixteenth aspect, alone or in combination with one or more of the first through fifteenth aspects, process 900 includes monitoring for a wake-up signal using a low-power wake-up radio when the UE is operating according to at least one of the light sleep mode or the deep sleep mode.

In a seventeenth aspect, alone or in combination with one or more of the first through sixteenth aspects, communicating the light sleep mode message includes receiving, from the network node, a light sleep mode command.

In an eighteenth aspect, alone or in combination with one or more of the first through seventeenth aspects, communicating the light sleep mode message includes transmitting, to the network node, the light sleep mode message, and receiving an acknowledgment message in response to the light sleep mode message, wherein entering the light sleep mode occurs after receiving the acknowledgement message.

In a nineteenth aspect, alone or in combination with one or more of the first through eighteenth aspects, process 900 includes receiving a wake-up signal, and activating the main radio transceiver from being partially deactivated to fully activated.

In a twentieth aspect, alone or in combination with one or more of the first through nineteenth aspects, process 900 includes deactivating the main radio transceiver of the UE in association with an expiry of the deep sleep mode timer, wherein deactivating the main radio transceiver causes a greater quantity of components of the main radio transceiver to be deactivated compared to a quantity of deactivated components of the main radio transceiver in the light sleep mode.

In a twenty-first aspect, alone or in combination with one or more of the first through twentieth aspects, process 900 includes receiving, while operating according to at least one of the light sleep mode or the deep sleep mode, a message prompting the UE to transition to an active mode, and receiving a control channel message in accordance with at least one of a first minimum time offset for transitioning from the light sleep mode to the active mode, or a second minimum time offset for transitioning from the deep sleep mode to the active mode.

In a twenty-second aspect, alone or in combination with one or more of the first through twenty-first aspects, the first minimum time offset and the second minimum time offset each define a duration between receiving the message and a time after which the main radio transceiver is capable of receiving the control channel message.

In a twenty-third aspect, alone or in combination with one or more of the first through twenty-second aspects, the first minimum time offset is shorter than the second minimum time offset.

In a twenty-fourth aspect, alone or in combination with one or more of the first through twenty-third aspects, communicating the light sleep mode message is in accordance with an expiry of a light sleep mode timer.

In a twenty-fifth aspect, alone or in combination with one or more of the first through twenty-fourth aspects, entering the light sleep mode is triggered by an expiry of an inactivity timer.

In a twenty-sixth aspect, alone or in combination with one or more of the first through twenty-fifth aspects, the main radio transceiver, while in the light sleep mode, is capable of processing a subset of signals associated with communications in an active mode.

In a twenty-seventh aspect, alone or in combination with one or more of the first through twenty-sixth aspects, the main radio transceiver, while in the deep sleep mode, is capable of processing a subset of signals associated with communications in the light sleep mode.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, at a UE or an apparatus of a UE. Example process 1000 is an example where the apparatus or the UE (e.g., UE 120) performs operations associated with timer-based sleep modes.

As shown in FIG. 10, in some aspects, process 1000 may include receiving, from a network node, a control channel message that schedules a communication between the UE and the network node, wherein a new data indicator of the control channel message indicates that the communication includes a new communication (block 1010). For example, the UE (e.g., using reception component 1302 or communication manager 1306, depicted in FIG. 13) may receive, from a network node, a control channel message that schedules a communication between the UE and the network node, wherein a new data indicator of the control channel message indicates that the communication includes a new communication, as described above.

As further shown in FIG. 10, in some aspects, process 1000 may include initiating a timer in reaction to receiving the control channel message, wherein the timer corresponds to the communication (block 1020). For example, the UE (e.g., using communication manager 1306, depicted in FIG. 13) may initiate a timer in reaction to receiving the control channel message, wherein the timer corresponds to the communication, as described above.

As further shown in FIG. 10, in some aspects, process 1000 may include overriding one or more discontinuous reception cycles for a duration of the timer according to a wake mode of the UE (block 1030). For example, the UE (e.g., using communication manager 1306, depicted in FIG. 13) may override one or more discontinuous reception cycles for a duration of the timer according to a wake mode of the UE, as described above.

Process 1000 may include additional aspects, such as any single aspect or any combination of aspects described below or in connection with one or more other processes described elsewhere herein.

In a first aspect, receiving the control channel message comprises receiving a control channel message scheduling a downlink communication, and the timer includes a downlink inactivity timer.

In a second aspect, alone or in combination with the first aspect, a duration of the downlink inactivity timer is shorter than a duration of a general inactivity timer.

In a third aspect, alone or in combination with one or more of the first and second aspects, receiving the control channel message comprises receiving a control channel message scheduling an uplink communication, wherein the timer includes an uplink inactivity timer.

In a fourth aspect, alone or in combination with one or more of the first through third aspects, a duration of the uplink inactivity timer is shorter than a duration of a general inactivity timer.

In a fifth aspect, alone or in combination with one or more of the first through fourth aspects, initiating the timer comprises initiating the timer in accordance with the new data indicator of the control channel message indicating that the communication includes a new downlink communication.

In a sixth aspect, alone or in combination with one or more of the first through fifth aspects, initiating the timer comprises initiating the timer in accordance with the new data indicator of the control channel message indicating that the communication includes a new uplink communication.

In a seventh aspect, alone or in combination with one or more of the first through sixth aspects, the control channel message includes an indication that explicitly indicates that the UE is to initiate the timer.

In an eighth aspect, alone or in combination with one or more of the first through seventh aspects, initiating the timer comprises initiating the timer in accordance with the control channel message being scrambled with a radio network temporary identifier that triggers initiation of the timer.

In a ninth aspect, alone or in combination with one or more of the first through eighth aspects, the control channel message schedules a plurality of communications and the timer includes a general inactivity timer.

In a tenth aspect, alone or in combination with one or more of the first through ninth aspects, the control channel message schedules a single communication and the timer includes a shortened inactivity timer.

In an eleventh aspect, alone or in combination with one or more of the first through tenth aspects, process 1000 includes receiving an additional control channel message that schedules a single communication, and refraining from initiating the timer in association with communicating the single communication.

In a twelfth aspect, alone or in combination with one or more of the first through eleventh aspects, a duration of the timer corresponds to a type of the communication or a quantity of scheduled communications.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, at a network node or an apparatus of a network node. Example process 1100 is an example where the apparatus or the network node (e.g., network node 110) performs operations associated with timer-based sleep modes.

As shown in FIG. 11, in some aspects, process 1100 may include communicating, with a UE, a light sleep mode message indicating activation of a light sleep mode, wherein the light sleep mode includes a first reduced power state in which a main radio transceiver of the UE is partially deactivated (block 1110). For example, the network node (e.g., using reception component 1402, transmission component 1404, or communication manager 1406, depicted in FIG. 14) may communicate, with a UE, a light sleep mode message indicating activation of a light sleep mode, wherein the light sleep mode includes a first reduced power state in which a main radio transceiver of the UE is partially deactivated, as described above.

As further shown in FIG. 11, in some aspects, process 1100 may include communicating with the UE according to a deep sleep mode timer for triggering a deep sleep mode of the UE, wherein the deep sleep mode includes a second reduced power state in which the main radio transceiver of the UE is more deactivated than in the light sleep mode (block 1120). For example, the network node (e.g., using reception component 1402, transmission component 1404, or communication manager 1406, depicted in FIG. 14) may communicate with the UE according to a deep sleep mode timer for triggering a deep sleep mode of the UE, wherein the deep sleep mode includes a second reduced power state in which the main radio transceiver of the UE is more deactivated than in the light sleep mode, as described above.

Process 1100 may include additional aspects, such as any single aspect or any combination of aspects described below or in connection with one or more other processes described elsewhere herein.

In a first aspect, process 1100 includes transmitting, to the UE while the deep sleep mode timer is activated, a message prompting the UE to wake up, wherein the UE enters an active mode in accordance with the message.

In a second aspect, alone or in combination with the first aspect, the message includes at least one of a wake-up signal, a scheduling message, a physical downlink control channel message, or a channel state information report request.

In a third aspect, alone or in combination with one or more of the first and second aspects, process 1100 includes transmitting a wake-up signal, wherein the wake-up signal prompts the UE to transition to an active mode from the light sleep mode.

In a fourth aspect, alone or in combination with one or more of the first through third aspects, process 1100 includes transmitting a wake-up signal, wherein the wake-up signal prompts the UE to transition to an active mode from the light sleep mode or to the light sleep mode from the deep sleep mode.

In a fifth aspect, alone or in combination with one or more of the first through fourth aspects, the wake-up signal includes an on-off keying signal.

In a sixth aspect, alone or in combination with one or more of the first through fifth aspects, a first ramp-up time for transitioning from the light sleep mode to an active mode is shorter than a second ramp-up time for transitioning from the deep sleep mode to the active mode.

In a seventh aspect, alone or in combination with one or more of the first through sixth aspects, the deep sleep mode timer is restarted in accordance with one or more network communication conditions being satisfied.

In an eighth aspect, alone or in combination with one or more of the first through seventh aspects, process 1100 includes transmitting a control message indicating a duration of the deep sleep mode timer.

In a ninth aspect, alone or in combination with one or more of the first through eighth aspects, process 1100 includes transmitting a network communication schedule, wherein a duration of the deep sleep mode timer is associated with a period of expected network inactivity indicated by the network communication schedule.

In a tenth aspect, alone or in combination with one or more of the first through ninth aspects, a duration of the deep sleep mode timer corresponds to a discontinuous reception cycle of the UE.

In an eleventh aspect, alone or in combination with one or more of the first through tenth aspects, process 1100 includes transmitting a control message indicating a future network communication, wherein a duration of the deep sleep mode timer is extended in accordance with the control message.

In a twelfth aspect, alone or in combination with one or more of the first through eleventh aspects, communicating the light sleep mode message includes transmitting, to the UE, a light sleep mode command.

In a thirteenth aspect, alone or in combination with one or more of the first through twelfth aspects, communicating the light sleep mode message includes receiving, from the UE, the light sleep mode message, and transmitting an acknowledgment message in response to the light sleep mode message, wherein the UE entering the light sleep mode occurs after transmitting the acknowledgement message.

In a fourteenth aspect, alone or in combination with one or more of the first through thirteenth aspects, process 1100 includes transmitting a message prompting the UE to transition to an active mode, and transmitting a control channel message in accordance with at least one of a first minimum time offset for transitioning from the light sleep mode to the active mode, or a second minimum time offset for transitioning from the deep sleep mode to the active mode.

In a fifteenth aspect, alone or in combination with one or more of the first through fourteenth aspects, the first minimum time offset and the second minimum time offset each define a duration between transmitting the message and a time after which the main radio transceiver of the UE is capable of receiving the control channel message.

In a sixteenth aspect, alone or in combination with one or more of the first through fifteenth aspects, the first minimum time offset is shorter than the second minimum time offset.

In a seventeenth aspect, alone or in combination with one or more of the first through sixteenth aspects, communicating the light sleep mode message is in accordance with an expiry of a light sleep mode timer.

In an eighteenth aspect, alone or in combination with one or more of the first through seventeenth aspects, entering the light sleep mode is triggered by an expiry of an inactivity timer.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, at a network node or an apparatus of a network node. Example process 1200 is an example where the apparatus or the network node (e.g., network node 110) performs operations associated with timer-based sleep modes.

As shown in FIG. 12, in some aspects, process 1200 may include transmitting, to a UE, a control channel message that schedules a communication between the UE and the network node, wherein a new data indicator of the control channel message indicates that the communication includes a new communication (block 1210). For example, the network node (e.g., using transmission component 1404 or communication manager 1406, depicted in FIG. 14) may transmit, to a UE, a control channel message that schedules a communication between the UE and the network node, wherein a new data indicator of the control channel message indicates that the communication includes a new communication, as described above.

As further shown in FIG. 12, in some aspects, process 1200 may include communicating with the UE while a timer that corresponds to the communication is activated (block 1220). For example, the network node (e.g., using reception component 1402, transmission component 1404, or communication manager 1406, depicted in FIG. 14) may communicate with the UE while a timer that corresponds to the communication is activated, as described above.

Process 1200 may include additional aspects, such as any single aspect or any combination of aspects described below or in connection with one or more other processes described elsewhere herein.

In a first aspect, transmitting the control channel message comprises transmitting a control channel message scheduling a downlink communication, and the timer includes a downlink inactivity timer.

In a second aspect, alone or in combination with the first aspect, a duration of the downlink inactivity timer is shorter than a duration of a general inactivity timer.

In a third aspect, alone or in combination with one or more of the first and second aspects, transmitting the control channel message comprises transmitting a control channel message scheduling an uplink communication, wherein the timer includes an uplink inactivity timer.

In a fourth aspect, alone or in combination with one or more of the first through third aspects, a duration of the uplink inactivity timer is shorter than a duration of a general inactivity timer.

In a fifth aspect, alone or in combination with one or more of the first through fourth aspects, the timer is initiated in accordance with the new data indicator of the control channel message indicating that the communication includes a new downlink communication.

In a sixth aspect, alone or in combination with one or more of the first through fifth aspects, the timer is initiated in accordance with the new data indicator of the control channel message indicating that the communication includes a new uplink communication.

In a seventh aspect, alone or in combination with one or more of the first through sixth aspects, the control channel message includes an indication that explicitly indicates that the UE is to initiate the timer.

In an eighth aspect, alone or in combination with one or more of the first through seventh aspects, the timer is initiated in accordance with the control channel message being scrambled with a radio network temporary identifier that triggers initiation of the timer.

In a ninth aspect, alone or in combination with one or more of the first through eighth aspects, the control channel message schedules a plurality of communications and the timer includes a general inactivity timer.

In a tenth aspect, alone or in combination with one or more of the first through ninth aspects, the control channel message schedules a single communication and the timer includes a shortened inactivity timer.

In an eleventh aspect, alone or in combination with one or more of the first through tenth aspects, a duration of the timer corresponds to a type of the communication or a quantity of scheduled communications.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram of an example apparatus 1300 for wireless communication. The apparatus 1300 may be a UE, or a UE may include the apparatus 1300. In some aspects, the apparatus 1300 includes a reception component 1302, a transmission component 1304, or a communication manager 1306, which may be in communication with one another (for example, via one or more buses or one or more other components). In some aspects, the communication manager 1306 is the communication manager 150 described in connection with FIG. 1. As shown, the apparatus 1300 may communicate with another apparatus 1308, such as a UE or a network node (such as a CU, a DU, an RU, or a base station), using the reception component 1302 and the transmission component 1304. The communication manager 1306 may be included in, or implemented via, a processing system (for example, the processing system 140 described in connection with FIG. 1) of the UE.

In some aspects, the apparatus 1300 may be configured to perform one or more operations described herein in connection with FIGS. 5-8. Additionally, or alternatively, the apparatus 1300 may be configured to perform one or more processes described herein, such as process 900 of FIG. 9, process 1000 of FIG. 10, or a combination thereof. In some aspects, the apparatus 1300 or one or more components shown in FIG. 13 may include one or more components of the UE described in connection with FIG. 1. Additionally, or alternatively, one or more components shown in FIG. 13 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1302 may receive communications, such as reference signals, control information, data communications, or a combination thereof, from the apparatus 1308. The reception component 1302 may provide received communications to one or more other components of the apparatus 1300. In some aspects, the reception component 1302 may perform signal processing on the received communications, and may provide the processed signals to the one or more other components of the apparatus 1300. In some aspects, the reception component 1302 may include one or more components of the UE described above in connection with FIG. 1, such as a radio, one or more RF chains, one or more transceivers, or one or more modems, each of which may in turn be coupled with one or more antennas of the UE.

The transmission component 1304 may transmit communications, such as reference signals, control information, data communications, or a combination thereof, to the apparatus 1308. In some aspects, one or more other components of the apparatus 1300 may generate communications and may provide the generated communications to the transmission component 1304 for transmission to the apparatus 1308. In some aspects, the transmission component 1304 may perform signal processing on the generated communications, and may transmit the processed signals to the apparatus 1308. In some aspects, the transmission component 1304 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1304 may be co-located with the reception component 1302.

The communication manager 1306 may support operations of the reception component 1302 or the transmission component 1304. For example, the communication manager 1306 may receive information associated with configuring reception of communications by the reception component 1302 or transmission of communications by the transmission component 1304. Additionally, or alternatively, the communication manager 1306 may generate or provide control information to the reception component 1302 or the transmission component 1304 to control reception or transmission of communications.

The reception component 1302 or the transmission component 1304 may communicate, with a network node, a light sleep mode message indicating activation of a light sleep mode, wherein the light sleep mode includes a first reduced power state in which a main radio transceiver of the UE is partially deactivated. The communication manager 1306 may enter the light sleep mode in accordance with communicating the light sleep mode indication. The communication manager 1306 may activate a deep sleep mode timer for entering a deep sleep mode in accordance with activating the light sleep mode, wherein the deep sleep mode includes a second reduced power state in which the main radio transceiver of the UE is more deactivated than in the light sleep mode.

The communication manager 1306 may transition from the light sleep mode to the deep sleep mode upon expiration of the deep sleep mode timer.

The communication manager 1306 may wake up from the deep sleep mode in response to a wake-up signal from the network node, wherein the wake-up signal prompts activation of the main radio transceiver.

The reception component 1302 may receive, from the network node while the deep sleep mode timer is activated, a message prompting the UE to wake up.

The communication manager 1306 may enter an active mode in accordance with receiving the message, wherein the active mode includes a full power state in which the main radio transceiver of the UE is fully activated.

The reception component 1302 may receive, using the main radio transceiver that is partially deactivated, a wake-up signal, wherein the wake-up signal prompts the UE to transition to an active mode from the light sleep mode.

The reception component 1302 may receive, using a low-power wake-up radio, a wake-up signal, wherein the wake-up signal prompts the UE to transition to an active mode from the light sleep mode or to the light sleep mode from the deep sleep mode.

The reception component 1302 may receive a control message indicating a duration of the deep sleep mode timer.

The reception component 1302 may receive a network communication schedule, wherein a duration of the deep sleep mode timer is selected in accordance with a period of expected network inactivity indicated by the network communication schedule.

The reception component 1302 may receive a control message indicating a future network communication.

The communication manager 1306 may extend a duration of the deep sleep mode timer in accordance with receiving the control message.

The communication manager 1306 may restart the deep sleep mode timer in accordance with receiving the control message.

The communication manager 1306 may monitor for a wake-up signal using a low-power wake-up radio when the UE is operating according to at least one of the light sleep mode or the deep sleep mode.

The reception component 1302 may receive a wake-up signal.

The communication manager 1306 may activate the main radio transceiver from being partially deactivated to fully activated.

The communication manager 1306 may deactivate the main radio transceiver of the UE in association with an expiry of the deep sleep mode timer, wherein deactivating the main radio transceiver causes a greater quantity of components of the main radio transceiver to be deactivated compared to a quantity of deactivated components of the main radio transceiver in the light sleep mode.

The reception component 1302 may receive, while operating according to at least one of the light sleep mode or the deep sleep mode, a message prompting the UE to transition to an active mode.

The reception component 1302 may receive a control channel message in accordance with at least one of a first minimum time offset for transitioning from the light sleep mode to the active mode, or a second minimum time offset for transitioning from the deep sleep mode to the active mode.

The reception component 1302 may receive, from a network node, a control channel message that schedules a communication between the UE and the network node, wherein a new data indicator of the control channel message indicates that the communication includes a new communication. The communication manager 1306 may initiate a timer in reaction to receiving the control channel message, wherein the timer corresponds to the communication. The communication manager 1306 may override one or more discontinuous reception cycles for a duration of the timer according to a wake mode of the UE.

The reception component 1302 may receive an additional control channel message that schedules a single communication.

The communication manager 1306 may refrain from initiating the timer in association with communicating the single communication.

The number and arrangement of components shown in FIG. 13 are provided as an example. In practice, there may be additional components, fewer components, different components, or differently arranged components than those shown in FIG. 13. Furthermore, two or more components shown in FIG. 13 may be implemented within a single component, or a single component shown in FIG. 13 may be implemented as multiple, distributed components. Additionally, or alternatively, a set of (one or more) components shown in FIG. 13 may perform one or more functions described as being performed by another set of components shown in FIG. 13.

FIG. 14 is a diagram of an example apparatus 1400 for wireless communication. The apparatus 1400 may be a network node, or a network node may include the apparatus 1400. In some aspects, the apparatus 1400 includes a reception component 1402, a transmission component 1404, or a communication manager 1406, which may be in communication with one another (for example, via one or more buses or one or more other components). In some aspects, the communication manager 1406 is the communication manager 155 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 145 described in connection with FIG. 1) of the network node.

In some aspects, the apparatus 1400 may be configured to perform one or more operations described herein in connection with FIGS. 5-8. Additionally, or alternatively, the apparatus 1400 may be configured to perform one or more processes described herein, such as process 1100 of FIG. 11, process 1200 of FIG. 12, or a combination thereof. In some aspects, the apparatus 1400 or one or more components shown in FIG. 14 may include one or more components of the network node described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the network node described above in connection with FIG. 1, such as a radio, one or more RF chains, one or more transceivers, or one or more modems, each of which may in turn be coupled with one or more antennas of the network node. In some aspects, the reception component 1402 or the transmission component 1404 may include or may be included in a network interface. The network interface may be configured to obtain or output signals for the apparatus 1400 via one or more communications links, such as a backhaul link, a midhaul link, or a fronthaul link.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1404 may be co-located with the reception component 1402.

The communication manager 1406 may support operations of the reception component 1402 or the transmission component 1404. For example, the communication manager 1406 may receive information associated with configuring reception of communications by the reception component 1402 or transmission of communications by the transmission component 1404. Additionally, or alternatively, the communication manager 1406 may generate or provide control information to the reception component 1402 or the transmission component 1404 to control reception or transmission of communications.

The reception component 1402 or the transmission component 1404 may communicate, with a UE, a light sleep mode message indicating activation of a light sleep mode, wherein the light sleep mode includes a first reduced power state in which a main radio transceiver of the UE is partially deactivated. The reception component 1402 or the transmission component 1404 may communicate with the UE according to a deep sleep mode timer for triggering a deep sleep mode of the UE, wherein the deep sleep mode includes a second reduced power state in which the main radio transceiver of the UE is more deactivated than in the light sleep mode.

The transmission component 1404 may transmit, to the UE while the deep sleep mode timer is activated, a message prompting the UE to wake up, wherein the UE enters an active mode in accordance with the message.

The transmission component 1404 may transmit a wake-up signal, wherein the wake-up signal prompts the UE to transition to an active mode from the light sleep mode.

The transmission component 1404 may transmit a wake-up signal, wherein the wake-up signal prompts the UE to transition to an active mode from the light sleep mode or to the light sleep mode from the deep sleep mode.

The transmission component 1404 may transmit a control message indicating a duration of the deep sleep mode timer.

The transmission component 1404 may transmit a network communication schedule, wherein a duration of the deep sleep mode timer is associated with a period of expected network inactivity indicated by the network communication schedule.

The transmission component 1404 may transmit a control message indicating a future network communication, wherein a duration of the deep sleep mode timer is extended in accordance with the control message.

The transmission component 1404 may transmit a message prompting the UE to transition to an active mode.

The transmission component 1404 may transmit a control channel message in accordance with at least one of a first minimum time offset for transitioning from the light sleep mode to the active mode, or a second minimum time offset for transitioning from the deep sleep mode to the active mode.

The transmission component 1404 may transmit, to a UE, a control channel message that schedules a communication between the UE and the network node, wherein a new data indicator of the control channel message indicates that the communication includes a new communication. The reception component 1402 or the transmission component 1404 may communicate with the UE while a timer that corresponds to the communication is activated.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

The following provides an overview of some Aspects of the present disclosure:

Aspect 1: A method of wireless communication performed by a user equipment (UE) comprising: communicating, with a network node, a light sleep mode message indicating activation of a light sleep mode, wherein the light sleep mode includes a first reduced power state in which a main radio transceiver of the UE is partially deactivated; entering the light sleep mode in accordance with communicating the light sleep mode indication; and activating a deep sleep mode timer for entering a deep sleep mode in accordance with activating the light sleep mode, wherein the deep sleep mode includes a second reduced power state in which the main radio transceiver of the UE is more deactivated than in the light sleep mode.

Aspect 2: The method of Aspect 1, further comprising: transitioning from the light sleep mode to the deep sleep mode upon expiration of the deep sleep mode timer.

Aspect 3: The method of Aspect 2, further comprising: waking up from the deep sleep mode in response to a wake-up signal from the network node, wherein the wake-up signal prompts activation of the main radio transceiver.

Aspect 4: The method of any of Aspects 1-3, further comprising: receiving, from the network node while the deep sleep mode timer is activated, a message prompting the UE to wake up; and entering an active mode in accordance with receiving the message, wherein the active mode includes a full power state in which the main radio transceiver of the UE is fully activated.

Aspect 5: The method of Aspect 4, wherein the message includes at least one of: a wake-up signal, a scheduling message, a physical downlink control channel message, or a channel state information report request.

Aspect 6: The method of any of Aspects 1-5, further comprising: receiving, using the main radio transceiver that is partially deactivated, a wake-up signal, wherein the wake-up signal prompts the UE to transition to an active mode from the light sleep mode.

Aspect 7: The method of any of Aspects 1-6, further comprising: receiving, using a low-power wake-up radio, a wake-up signal, wherein the wake-up signal prompts the UE to transition to an active mode from the light sleep mode or to the light sleep mode from the deep sleep mode.

Aspect 8: The method of Aspect 7, wherein the wake-up signal includes an on-off keying signal.

Aspect 9: The method of any of Aspects 1-8, wherein a first ramp-up time for transitioning from the light sleep mode to an active mode is shorter than a second ramp-up time for transitioning from the deep sleep mode to the active mode.

Aspect 10: The method of any of Aspects 1-9, wherein the deep sleep mode timer is restarted in accordance with one or more network communication conditions being satisfied.

Aspect 11: The method of any of Aspects 1-10, further comprising: receiving a control message indicating a duration of the deep sleep mode timer.

Aspect 12: The method of any of Aspects 1-11, further comprising: receiving a network communication schedule, wherein a duration of the deep sleep mode timer is selected in accordance with a period of expected network inactivity indicated by the network communication schedule.

Aspect 13: The method of any of Aspects 1-12, wherein a duration of the deep sleep mode timer corresponds to a discontinuous reception cycle of the UE.

Aspect 14: The method of any of Aspects 1-13, further comprising: receiving a control message indicating a future network communication.

Aspect 15: The method of Aspect 14, further comprising: extending a duration of the deep sleep mode timer in accordance with receiving the control message.

Aspect 16: The method of Aspect 14, further comprising: restarting the deep sleep mode timer in accordance with receiving the control message.

Aspect 17: The method of any of Aspects 1-16, further comprising: monitoring for a wake-up signal using a low-power wake-up radio when the UE is operating according to at least one of the light sleep mode or the deep sleep mode.

Aspect 18: The method of any of Aspects 1-17, wherein communicating the light sleep mode message includes: receiving, from the network node, a light sleep mode command.

Aspect 19: The method of any of Aspects 1-18, wherein communicating the light sleep mode message includes: transmitting, to the network node, the light sleep mode message; and receiving an acknowledgment message in response to the light sleep mode message, wherein entering the light sleep mode occurs after receiving the acknowledgement message.

Aspect 20: The method of any of Aspects 1-19, further comprising: receiving a wake-up signal; and activating the main radio transceiver from being partially deactivated to fully activated.

Aspect 21: The method of any of Aspects 1-20, deactivating the main radio transceiver of the UE in association with an expiry of the deep sleep mode timer, wherein deactivating the main radio transceiver causes a greater quantity of components of the main radio transceiver to be deactivated compared to a quantity of deactivated components of the main radio transceiver in the light sleep mode.

Aspect 22: The method of any of Aspects 1-21, further comprising: receiving, while operating according to at least one of the light sleep mode or the deep sleep mode, a message prompting the UE to transition to an active mode; and receiving a control channel message in accordance with at least one of: a first minimum time offset for transitioning from the light sleep mode to the active mode, or a second minimum time offset for transitioning from the deep sleep mode to the active mode.

Aspect 23: The method of Aspect 22, wherein the first minimum time offset and the second minimum time offset each define a duration between receiving the message and a time after which the main radio transceiver is capable of receiving the control channel message.

Aspect 24: The method of Aspect 22, wherein the first minimum time offset is shorter than the second minimum time offset.

Aspect 25: The method of any of Aspects 1-24, wherein communicating the light sleep mode message is in accordance with an expiry of a light sleep mode timer.

Aspect 26: The method of any of Aspects 1-25, wherein entering the light sleep mode is triggered by an expiry of an inactivity timer.

Aspect 27: The method of any of Aspects 1-26, wherein the main radio transceiver, while in the light sleep mode, is capable of processing a subset of signals associated with communications in an active mode.

Aspect 28: The method of any of Aspects 1-27, wherein the main radio transceiver, while in the deep sleep mode, is capable of processing a subset of signals associated with communications in the light sleep mode.

Aspect 29: A method of wireless communication performed by a user equipment (UE) comprising: receiving, from a network node, a control channel message that schedules a communication between the UE and the network node, wherein a new data indicator of the control channel message indicates that the communication includes a new communication; initiating a timer in reaction to receiving the control channel message, wherein the timer corresponds to the communication; and overriding one or more discontinuous reception cycles for a duration of the timer according to a wake mode of the UE.

Aspect 30: The method of Aspect 29, wherein receiving the control channel message comprises: receiving a control channel message scheduling a downlink communication, and wherein the timer includes a downlink inactivity timer.

Aspect 31: The method of Aspect 30, wherein a duration of the downlink inactivity timer is shorter than a duration of a general inactivity timer.

Aspect 32: The method of any of Aspects 29-31, wherein receiving the control channel message comprises: receiving a control channel message scheduling an uplink communication, wherein the timer includes an uplink inactivity timer.

Aspect 33: The method of Aspect 32, wherein a duration of the uplink inactivity timer is shorter than a duration of a general inactivity timer.

Aspect 34: The method of any of Aspects 29-33, wherein initiating the timer comprises: initiating the timer in accordance with the new data indicator of the control channel message indicating that the communication includes a new downlink communication.

Aspect 35: The method of any of Aspects 29-34, wherein initiating the timer comprises: initiating the timer in accordance with the new data indicator of the control channel message indicating that the communication includes a new uplink communication.

Aspect 36: The method of any of Aspects 29-35, wherein the control channel message includes an indication that explicitly indicates that the UE is to initiate the timer.

Aspect 37: The method of any of Aspects 29-36, wherein initiating the timer comprises: initiating the timer in accordance with the control channel message being scrambled with a radio network temporary identifier that triggers initiation of the timer.

Aspect 38: The method of any of Aspects 29-37, wherein the control channel message schedules a plurality of communications and the timer includes a general inactivity timer.

Aspect 39: The method of any of Aspects 29-38, wherein the control channel message schedules a single communication and the timer includes a shortened inactivity timer.

Aspect 40: The method of any of Aspects 29-39, further comprising: receiving an additional control channel message that schedules a single communication; and refraining from initiating the timer in association with communicating the single communication.

Aspect 41: The method of any of Aspects 29-40, wherein a duration of the timer corresponds to a type of the communication or a quantity of scheduled communications.

Aspect 42: A method of wireless communication performed by a network node, comprising: communicating, with a user equipment (UE), a light sleep mode message indicating activation of a light sleep mode, wherein the light sleep mode includes a first reduced power state in which a main radio transceiver of the UE is partially deactivated; and communicating with the UE according to a deep sleep mode timer for triggering a deep sleep mode of the UE, wherein the deep sleep mode includes a second reduced power state in which the main radio transceiver of the UE is more deactivated than in the light sleep mode.

Aspect 43: The method of Aspect 42, further comprising: transmitting, to the UE while the deep sleep mode timer is activated, a message prompting the UE to wake up, wherein the UE enters an active mode in accordance with the message.

Aspect 44: The method of Aspect 43, wherein the message includes at least one of: a wake-up signal, a scheduling message, a physical downlink control channel message, or a channel state information report request.

Aspect 45: The method of any of Aspects 42-44, further comprising: transmitting a wake-up signal, wherein the wake-up signal prompts the UE to transition to an active mode from the light sleep mode.

Aspect 46: The method of any of Aspects 42-45, further comprising: transmitting a wake-up signal, wherein the wake-up signal prompts the UE to transition to an active mode from the light sleep mode or to the light sleep mode from the deep sleep mode.

Aspect 47: The method of Aspect 46, wherein the wake-up signal includes an on-off keying signal.

Aspect 48: The method of any of Aspects 42-47, wherein a first ramp-up time for transitioning from the light sleep mode to an active mode is shorter than a second ramp-up time for transitioning from the deep sleep mode to the active mode.

Aspect 49: The method of any of Aspects 42-48, wherein the deep sleep mode timer is restarted in accordance with one or more network communication conditions being satisfied.

Aspect 50: The method of any of Aspects 42-49, further comprising: transmitting a control message indicating a duration of the deep sleep mode timer.

Aspect 51: The method of any of Aspects 42-50, further comprising: transmitting a network communication schedule, wherein a duration of the deep sleep mode timer is associated with a period of expected network inactivity indicated by the network communication schedule.

Aspect 52: The method of any of Aspects 42-51, wherein a duration of the deep sleep mode timer corresponds to a discontinuous reception cycle of the UE.

Aspect 53: The method of any of Aspects 42-52, further comprising: transmitting a control message indicating a future network communication, wherein a duration of the deep sleep mode timer is extended in accordance with the control message.

Aspect 54: The method of any of Aspects 42-53, wherein communicating the light sleep mode message includes: transmitting, to the UE, a light sleep mode command.

Aspect 55: The method of any of Aspects 42-54, wherein communicating the light sleep mode message includes: receiving, from the UE, the light sleep mode message; and transmitting an acknowledgment message in response to the light sleep mode message, wherein the UE entering the light sleep mode occurs after transmitting the acknowledgement message.

Aspect 56: The method of any of Aspects 42-55, further comprising: transmitting a message prompting the UE to transition to an active mode; and transmitting a control channel message in accordance with at least one of: a first minimum time offset for transitioning from the light sleep mode to the active mode, or a second minimum time offset for transitioning from the deep sleep mode to the active mode.

Aspect 58: The method of Aspect 56, wherein the first minimum time offset is shorter than the second minimum time offset.

Aspect 59: The method of any of Aspects 42-58, wherein communicating the light sleep mode message is in accordance with an expiry of a light sleep mode timer.

Aspect 60: The method of any of Aspects 42-59, wherein entering the light sleep mode is triggered by an expiry of an inactivity timer.

Aspect 61: A method of wireless communication performed by a network node, comprising: transmitting, to a user equipment (UE), a control channel message that schedules a communication between the UE and the network node, wherein a new data indicator of the control channel message indicates that the communication includes a new communication; and communicating with the UE while a timer that corresponds to the communication is activated.

Aspect 62: The method of Aspect 61, wherein transmitting the control channel message comprises: transmitting a control channel message scheduling a downlink communication, and wherein the timer includes a downlink inactivity timer.

Aspect 63: The method of Aspect 62, wherein a duration of the downlink inactivity timer is shorter than a duration of a general inactivity timer.

Aspect 64: The method of any of Aspects 61-63, wherein transmitting the control channel message comprises: transmitting a control channel message scheduling an uplink communication, wherein the timer includes an uplink inactivity timer.

Aspect 65: The method of Aspect 64, wherein a duration of the uplink inactivity timer is shorter than a duration of a general inactivity timer.

Aspect 66: The method of any of Aspects 61-65, wherein the timer is initiated in accordance with the new data indicator of the control channel message indicating that the communication includes a new downlink communication.

Aspect 67: The method of any of Aspects 61-66, wherein the timer is initiated in accordance with the new data indicator of the control channel message indicating that the communication includes a new uplink communication.

Aspect 68: The method of any of Aspects 61-67, wherein the control channel message includes an indication that explicitly indicates that the UE is to initiate the timer.

Aspect 69: The method of any of Aspects 61-68, wherein the timer is initiated in accordance with the control channel message being scrambled with a radio network temporary identifier that triggers initiation of the timer.

Aspect 70: The method of any of Aspects 61-69, wherein the control channel message schedules a plurality of communications and the timer includes a general inactivity timer.

Aspect 71: The method of any of Aspects 61-70, wherein the control channel message schedules a single communication and the timer includes a shortened inactivity timer.

Aspect 72: The method of any of Aspects 61-71, wherein a duration of the timer corresponds to a type of the communication or a quantity of scheduled communications.

Aspect 73: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-72.

Aspect 74: An apparatus for wireless communication at a device, the apparatus comprising one or more memories and one or more processors coupled to the one or more memories, the one or more processors configured to cause the device to perform the method of one or more of Aspects 1-72.

Aspect 75: An apparatus for wireless communication, the apparatus comprising at least one means for performing the method of one or more of Aspects 1-72.

Aspect 76: A non-transitory computer-readable medium storing code for wireless communication, the code comprising instructions executable by one or more processors to perform the method of one or more of Aspects 1-72.

Aspect 77: A non-transitory computer-readable medium storing a set of instructions for wireless communication, the set of instructions comprising one or more instructions that, when executed by one or more processors of a device, cause the device to perform the method of one or more of Aspects 1-72.

Aspect 78: A device for wireless communication, the device comprising a processing system that includes one or more processors and one or more memories coupled with the one or more processors, the processing system configured to cause the device to perform the method of one or more of Aspects 1-72.

Aspect 79: An apparatus for wireless communication at a device, the apparatus comprising one or more memories and one or more processors coupled to the one or more memories, the one or more processors individually or collectively configured to cause the device to perform the method of one or more of Aspects 1-72.

Aspect 80: A device comprising a processing system that includes one or more processors and one or more code-storing memories coupled with the one or more processors, the processing system configured to cause the device to perform the method of one or more of Aspects 1-72.

Aspect 81: A device comprising a processing system that includes processor circuitry and code-storing memory circuitry, the processing system configured to cause the device to perform the method of one or more of Aspects 1-72.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A user equipment (UE), comprising:
a processing system that includes one or more processors and one or more code-storing memories coupled with the one or more processors, the processing system configured to cause the UE to:
communicate, with a network node, a light sleep mode message indicating activation of a light sleep mode, wherein the light sleep mode includes a first reduced power state in which a main radio transceiver of the UE is partially deactivated;
enter the light sleep mode in accordance with communicating the light sleep mode indication; and
activate a deep sleep mode timer for entering a deep sleep mode in accordance with activating the light sleep mode, wherein the deep sleep mode includes a second reduced power state in which the main radio transceiver of the UE is more deactivated than in the light sleep mode.

2. The UE of claim 1, wherein the processing system is configured to cause the UE to:
transition from the light sleep mode to the deep sleep mode upon expiration of the deep sleep mode timer.

3. The UE of claim 1, wherein the processing system is configured to cause the UE to:
receive, from the network node while the deep sleep mode timer is activated, a message prompting the UE to wake up; and
enter an active mode in accordance with receiving the message, wherein the active mode includes a full power state in which the main radio transceiver of the UE is fully activated.

4. The UE of claim 1, wherein the processing system is configured to cause the UE to:
receive, using the main radio transceiver that is partially deactivated, a wake-up signal, wherein the wake-up signal prompts the UE to transition to an active mode from the light sleep mode.

5. The UE of claim 1, wherein the processing system is configured to cause the UE to:
receive, using a low-power wake-up radio, a wake-up signal, wherein the wake-up signal prompts the UE to transition to an active mode from the light sleep mode or to the light sleep mode from the deep sleep mode.

6. The UE of claim 1, wherein the processing system is configured to cause the UE to:
receive a network communication schedule, wherein a duration of the deep sleep mode timer is selected in accordance with a period of expected network inactivity indicated by the network communication schedule.

7. The UE of claim 1, wherein the processing system, to cause the UE to communicate the light sleep mode message, is configured to cause the UE to:
receive, from the network node, a light sleep mode command.

8. The UE of claim 1, wherein the processing system, to cause the UE to communicate the light sleep mode message, is configured to cause the UE to:
transmit, to the network node, the light sleep mode message; and
receive an acknowledgment message in response to the light sleep mode message, wherein entering the light sleep mode occurs after receiving the acknowledgement message.

9. The UE of claim 1, wherein the processing system is configured to cause the UE to:
receive a wake-up signal; and
activate the main radio transceiver from being partially deactivated to fully activated.

10. The UE of claim 1, wherein the processing system is configured to cause the UE to:
deactivate the main radio transceiver of the UE in association with an expiry of the deep sleep mode timer, wherein deactivating the main radio transceiver causes a greater quantity of components of the main radio transceiver to be deactivated compared to a quantity of deactivated components of the main radio transceiver in the light sleep mode.

11. The UE of claim 1, wherein the processing system is configured to cause the UE to:
receive, while operating according to at least one of the light sleep mode or the deep sleep mode, a message prompting the UE to transition to an active mode; and
receive a control channel message in accordance with at least one of:
a first minimum time offset for transitioning from the light sleep mode to the active mode, or
a second minimum time offset for transitioning from the deep sleep mode to the active mode.

12. A user equipment (UE), comprising:
a processing system that includes one or more processors and one or more code-storing memories coupled with the one or more processors, the processing system configured to cause the UE to:
receive, from a network node, a control channel message that schedules a communication between the UE and the network node, wherein a new data indicator of the control channel message indicates that the communication includes a new communication;
initiate a timer in reaction to receiving the control channel message, wherein the timer corresponds to the communication; and
override one or more discontinuous reception cycles for a duration of the timer according to a wake mode of the UE.

13. The UE of claim 12, wherein the processing system, to cause the UE to receive the control channel message, is configured to cause the UE to:
receive a control channel message scheduling a downlink communication, and wherein the timer includes a downlink inactivity timer.

14. The UE of claim 12, wherein the processing system, to cause the UE to receive the control channel message, is configured to cause the UE to:
receive a control channel message scheduling an uplink communication, wherein the timer includes an uplink inactivity timer.

15. The UE of claim 12, wherein the processing system, to cause the UE to initiate the timer, is configured to cause the UE to:
initiate the timer in accordance with the new data indicator of the control channel message indicating that the communication includes a new downlink communication.

16. The UE of claim 12, wherein the processing system, to cause the UE to initiate the timer, is configured to cause the UE to:
initiate the timer in accordance with the new data indicator of the control channel message indicating that the communication includes a new uplink communication.

17. The UE of claim 12, wherein the processing system, to cause the UE to initiate the timer, is configured to cause the UE to:
initiate the timer in accordance with the control channel message being scrambled with a radio network temporary identifier that triggers initiation of the timer.

18. The UE of claim 12, wherein the processing system is configured to cause the UE to:
receive an additional control channel message that schedules a single communication; and
refrain from initiating the timer in association with communicating the single communication.

19. The UE of claim 12, wherein a duration of the timer corresponds to a type of the communication or a quantity of scheduled communications.

20. A method of wireless communication performed by a user equipment (UE) comprising:
communicating, with a network node, a light sleep mode message indicating activation of a light sleep mode, wherein the light sleep mode includes a first reduced power state in which a main radio transceiver of the UE is partially deactivated;
entering the light sleep mode in accordance with communicating the light sleep mode indication; and
activating a deep sleep mode timer for entering a deep sleep mode in accordance with activating the light sleep mode, wherein the deep sleep mode includes a second reduced power state in which the main radio transceiver of the UE is more deactivated than in the light sleep mode.
